(19) United States
(12) Patent Application Publication
(10) Pub. No.: US 2026/0357166 A1
(43) Pub. Date: Nov. 12, 2026

(54) WATER-SOLUBLE UNIT DOSE SOLID DETERGENT ARTICLE COMPRISING PROTEASES

(71) Applicant: THE PROCTER & GAMBLE COMPANY, Cincinnati, OH (US)

(72) Inventors: Lindsey HEATHCOTE, Northumberland (GB); Michelle JACKSON, Newcastle upon Tyne (GB); Carl David MAC NAMARA, Beijing (CN); Mark Robert SIVIK, Mason, OH (US); Philip Frank SOUTER, Morpeth Northumberland (GB)

(21) Appl. No.: 19/669,031

(22) Filed: May 6, 2026

(30) Foreign Application Priority Data
May 9, 2025 (WO) PCT/CN2025/093879

(51) Int. Cl. C11D 17/06; C11D 1/22; C11D 1/29; C11D 1/75; C11D 3/12; C11D 3/20; C11D 3/37; C11D 3/386; C11D 3/395; C11D 3/50

(52) U.S. Cl. CPC C11D 17/06; C11D 1/22; C11D 1/29; C11D 1/75; C11D 3/128; C11D 3/2065; C11D 3/3753; C11D 3/38609; C11D 3/3955; C11D 3/505; C11D 2111/12

(57) ABSTRACT

A water-soluble unit-dose solid detergent article including a porous structure, the article includes a surfactant system, a serine protease and a metalloprotease.

### TECHNICAL FIELD

The present disclosure relates to a water-soluble unit-dose solid detergent article comprising a porous structure. The water-soluble unit-dose solid detergent article comprises a surfactant system, a serine protease and a metalloprotease. It also relates to method of using said solid article.

### REFERENCE TO AN ELECTRONIC SEQUENCE LISTING

This application contains a Sequence Listing in computer readable form. The contents of the electronic sequence listing (CM05862_Sequence.xml; Size: 4,445 bytes; and Date of Creation: 17 Mar. 2026) is herein incorporated by reference in its entirety.

### BACKGROUND

Water-soluble unit-dose detergent articles in solid form comprising surfactant(s) and other active ingredients in a water-soluble polymeric carrier or matrix are well known. Such detergent articles are particularly useful for delivering surfactants and other active ingredients upon dissolution in water. In comparison with traditional granular or liquid detergents in the same product category, such detergent articles can have better structural integrity, are more concentrated and easier to store, ship/transport, carry, and handle. Such detergent articles seem to have good sensory appeal to the consumers, in particular when used in laundry.

During the laundry process, the pH of the wash water can change significantly due to the introduction of soil and contaminants from the soiled fabrics. As the fabrics release dirt, oils, and organic materials, these substances can interact with the wash water, altering its chemical composition. For instance, many types of soil, such as sweat or food residues, can be acidic, which may lower the pH of the wash water. Conversely, certain detergents and additives used in laundry are often alkaline, which can raise the pH of the wash water. This dynamic interaction between the soil and the wash water not only influences the effectiveness of the cleaning agents but also impacts the overall washing performance, as the pH level plays a crucial role in the solubility of stains and the activity of actives in the detergent.

Detergent products can provide sub-optimal proteinaceous stain removal. The pH modification can negatively impact the performance of proteases during the wash.

There is therefore a need for a water-soluble unit-dose solid detergent article providing improved proteinaceous stain removal across a broad pH range.

### SUMMARY

In one aspect, the present disclosure, in an example, provides a water-soluble unit-dose solid detergent article, which comprises:
a surfactant system
a serine protease; and
a metalloprotease.

The water-soluble unit-dose solid detergent article is in solid form and has a porous structure.

Preferably, the detergent article is characterized by one or more of the following parameters:
a Percent Open Cell Content of from about 80% to 100%, preferably from about 85% to 100%, more preferably from about 90% to 100%; and/or
an Overall Average Pore Size of from about 100 μm to about 2000 μm, from about 150 μm to about 1000 μm, preferably from about 200 μm to about 600 μm; and/or
an Average Cell Wall Thickness of from about 5 μm to about 200 μm, preferably from about 10 μm to about 100 μm, more preferably from about 10 μm to about 80 μm; and/or
a final moisture content of from about 0.5% to about 25%, preferably from about 1% to about 20%, more preferably from about 3% to about 10%, by weight of said solid sheet article; and/or
a thickness of from about 0.5 mm to about 4 mm, preferably from about 0.6 mm to about 3.5 mm, more preferably from about 0.7 mm to about 3 mm, still more preferably from about 0.8 mm to about 2 mm, most preferably from about 1 mm to about 1.5 mm; and/or
a basis weight of from about 50 grams/m² to about 250 grams/m², preferably from about 80 grams/m² to about 220 grams/m², more preferably from about 100 grams/m² to about 200 grams/m²; and/or
a density of from about 0.05 grams/cm³ to about 0.5 grams/cm³, preferably from about 0.06 grams/cm³ to about 0.4 grams/cm³, more preferably from about 0.07 grams/cm³ to about 0.2 grams/cm³, most preferably from about 0.08 grams/cm³ to about 0.15 grams/cm³; and/or
a Specific Surface Area of from about 0.03 m²/g to about 0.25 m²/g, preferably from about 0.04 m²/g to about 0.22 m²/g, more preferably from about 0.05 m²/g to about 0.2 m²/g, most preferably from about 0.1 m²/g to about 0.18 m²/g.

According to another aspect, there is provided a method of cleaning a surface, preferably a fabric, using the solid article.

These and other aspects of the present disclosure will become more apparent upon reading the following detailed description.

### DETAILED DESCRIPTION

### I. Definitions

The term “solid” as used herein refers to the ability of an article to substantially retain its shape (i.e., without any visible change in its shape) at 20 °C and under the atmospheric pressure, when it is not confined and when no external force is applied thereto.

The term “flexible” as used herein refers to the ability of an article to withstand stress without breakage or significant fracture when it is bent at 90° along a center line perpendicular to its longitudinal direction. Preferably, such article can undergo significant elastic deformation and is characterized by a Young's Modulus of no more than 5 GPa, preferably no more than 1 GPa, more preferably no more than 0.5 GPa, most preferably no more than 0.2 GPa.

The term “dissolvable” as used herein refers to the ability of an article to completely or substantially dissolve in a sufficient amount of deionized water at 20 °C and under the atmospheric pressure within eight (8) hours without any stirring, leaving less than 5 wt % undissolved residues.

The term “sheet” as used herein refers to a non-fibrous structure having a three-dimensional shape, i.e., with a thickness, a length, and a width, while the length-to-thickness aspect ratio and the width-to-thickness aspect ratio are both at least about 5:1, and the length-to-width ratio is at least about 1:1. Preferably, the length-to-thickness aspect ratio and the width-to-thickness aspect ratio are both at least about 10:1, more preferably at least about 15:1, most preferably at least about 20:1; and the length-to-width aspect ratio is preferably at least about 1.2:1, more preferably at least about 1.5:1, most preferably at least about 1.618:1.

The term “sulfonates” or “sulfates” as used herein refers to compounds in either an un-neutralized sulfonic acid or sulfuric acid form, or a neutralized salt form, or as a mixture of both (i.e., partially neutralized).

The term “polyvinyl alcohol” or “polyvinyl alcohols” or “PVA” or “PVAs” as used herein include both homopolymers and copolymers of polyvinyl alcohol. The copolymers may include a vinyl alcohol monomer and one or more monomers of another type.

The term “water-soluble” as used herein refers to the ability of a sample material to completely dissolve in or disperse into water leaving no visible solids or forming no visibly separate phase, when at least about 25 grams, preferably at least about 50 grams, more preferably at least about 100 grams, most preferably at least about 200 grams, of such material is placed in one liter (1 L) of deionized water at 20 °C and under the atmospheric pressure with sufficient stirring.

As used herein, the term “starch” refers to both naturally occurring or modified starches. Typical natural sources for starches can include cereals, tubers, roots, legumes and fruits. More specific natural sources can include corn, pea, potato, banana, barley, wheat, rice, sago, amaranth, tapioca, arrowroot, canna, sorghum, and waxy or high amylase varieties thereof. The natural starches can be modified by any modification method known in the art to form modified starches, including physically modified starches, such as sheared starches or thermally-inhibited starches; chemically modified starches, such as those which have been cross-linked, acetylated, and organically esterified, hydroxyethylated, and hydroxypropylated, phosphorylated, and inorganically esterified, cationic, anionic, nonionic, amphoteric and zwitterionic, and succinate and substituted succinate derivatives thereof; conversion products derived from any of the starches, including fluidity or thin-boiling starches prepared by oxidation, enzyme conversion, acid hydrolysis, heat or acid dextrinization, thermal and or sheared products may also be useful herein; and pregelatinized starches which are known in the art.

The term “open celled foam” or “open cell pore structure” as used herein refers to a solid, interconnected, polymer-containing matrix that defines a network of spaces or cells that contain a gas, typically a gas (such as air), without collapse of the foam structure during the drying process, thereby maintaining the physical strength and cohesiveness of the solid. The interconnectivity of the structure may be described by a Percent Open Cell Content, which is measured by Test 3 disclosed hereinafter.

As used herein, in the case of a sheet, the term “bottom surface” refers to a surface of the sheet that is immediately contacting a supporting surface upon which the sheet of aerated wet pre-mixture is placed during the drying step, while the term “top surface” refers to a surface of said sheet that is opposite to the bottom surface. Further, such solid sheet can be divided into three (3) regions along its thickness, including a top region that is adjacent to its top surface, a bottom region that is adjacent to its bottom surface, and a middle region that is located between the top and bottom regions. The top, middle, and bottom regions are of equal thickness, i.e., each having a thickness that is about ⅓ of the total thickness of the sheet. Similar definitions are used for the “bottom surface” and “top surface” of the solid article.

The term “aerate”, “aerating” or “aeration” as used herein refers to a process of introducing a gas into a liquid or pasty composition by mechanical and/or chemical means.

The term “heating direction” as used herein refers to the direction along which a heat source applies thermal energy to an article, which results in a temperature gradient in such article that decreases from one side of such article to the other side. For example, if a heat source located at one side of the article applies thermal energy to said article to generate a temperature gradient that decreases from said one side to an opposing side, the heating direction is then deemed as extending from said one side to the opposing side. If both sides of such article, or different sections of such article, are heated simultaneously with no observable temperature gradient across such article, then the heating is carried out in a non-directional manner, and there is no heating direction.

The term “substantially opposite to” or “substantially offset from” as used herein refers to two directions or two lines having an offset angle of 90° or more therebetween.

The term “substantially aligned” or “substantial alignment” as used herein refers to two directions or two lines having an offset angle of less than 90° therebetween.

The term “primary heat source” as used herein refers to a heat source that provides more than 50%, preferably more than 60%, more preferably more than 70%, most preferably more than 80%, of the total thermal energy absorbed by an object (e.g., the sheet of aerated wet pre-mixture according to the present disclosure).

The term “controlled surface temperature” as used herein refers to a surface temperature that is relatively consistent, i.e., with less than +/−20% fluctuations, preferably less than +/−10% fluctuations, more preferably less than +/−5% fluctuations.

The term “essentially free of” or “essentially free from” means that the indicated material is at the very minimal not deliberately added to the composition or product, or preferably not present at an analytically detectible level in such composition or product. It may include compositions or products in which the indicated material is present only as an impurity of one or more of the materials deliberately added to such compositions or products.

It has been a surprising and unexpected discovery of the present disclosure that the use of serine proteases and metalloproteases give rise to a synergy across a wide range of pHs.

### II. Formulations of Inventive Solid Article

### 1. Polyvinyl Alcohol (PVA)

The solid article of the present disclosure may comprise polyvinyl alcohol (PVA) polymer or copolymer thereof as a film-former, a structurant as well as a carrier for the surfactant(s), proteases and optionally other active ingredients (e.g., emulsifiers, builders, chelants, perfumes, colorants, and the like). It is preferred that the PVA polymer or copolymer is present in the solid article of the present disclosure in an amount ranging from about 5% to about 50%, preferably from about 10% to about 40%, preferably from about 15% to about 30%, more preferably from about 20% to about 25%, by total weight of the solid article. In a particularly preferred embodiment of the present disclosure, the total amount of PVA(s) present in the solid article of the present disclosure is no more than 25% by total weight of such solid article.

PVA polymers or copolymers suitable for the practice of the present disclosure are selected from those with weight average molecular weights ranging from about 50,000 to about 400,000 Daltons, preferably from about 60,000 to about 300,000 Daltons, more preferably from about 70,000 to about 200,000 Daltons, most preferably from about 80,000 to about 150,000 Daltons. The weight average molecular weight is computed by summing the average molecular weights of each polymer raw material multiplied by their respective relative weight percentages by weight of the total weight of polymers present within the porous solid.

The solid article of the present disclosure is preferably made by first forming a wet pre-mixture containing the PVA, the surfactant(s) and optionally other active ingredients, followed by shaping the wet pre-mixture into a sheet and then drying such sheet of wet pre-mixture to form a solidified sheet article. Correspondingly, the weight average molecular weight of the PVA polymer or copolymer may affect the overall film-forming properties of the wet pre-mixture and its compatibility/incompatibility with the desired surfactants. Further, the weight average molecular weight of the PVA polymer or copolymer used herein may impact the viscosity of the wet pre-mixture, which may in turn influence various physical properties of the resulting solid article so formed.

The PVA polymer or copolymer of the present disclosure may further be characterized by a degree of hydrolysis ranging from about 40% to about 100%, preferably from about 50% to about 95%, more preferably from about 70% to about 92%, most preferably from about 80% to about 90%.

The PVA copolymer of the present disclosure may include a vinyl alcohol monomer and one or more monomers of any other type. Preferred PVA copolymers for the practice of the present disclosure include, in addition to the vinyl alcohol monomer and one or more anionic monomers represented by Formula (I) and/or (II) at below:

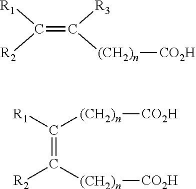

wherein R₁, R₂ and R₃ are each independently H or methyl, and n is independently an integer of 0 to 3. The above-described anionic monomeric unit, if present, is preferably present in an amount ranging from about 0.5 to about 5 mol %.

Commercially available polyvinyl alcohols include those from Celanese Corporation (Texas, USA) under the CELVOL trade name including, but not limited to, CELVOL 523, CELVOL 530, CELVOL 540, CELVOL 518, CELVOL 513, CELVOL 508, CELVOL 504; those from Kuraray Europe GmbH (Frankfurt, Germany) under the Mowiol® and POVAL™ trade names; and PVA 1788 (also referred to as PVA BP17) commercially available from various suppliers including Lubon Vinylon Co. (Nanjing, China); and combinations thereof. In a particularly preferred embodiment of the present disclosure, the solid article comprises from about 10% to about 25%, more preferably from about 15% to about 23%, by total weight of such article, of a polyvinyl alcohol having a weight average molecular weight ranging from 80,000 to about 150,000 Daltons and a degree of hydrolysis ranging from about 80% to about 90%.

In addition to PVAs as mentioned hereinabove, a single starch or a combination of starches may be used as a filler material in such an amount as to reduce the overall level of PVAs required, so long as it helps provide the solid article with the requisite structure and physical/chemical characteristics as described herein. However, too much starch may comprise the solubility and structural integrity of the solid article. Therefore, in preferred embodiments of the present disclosure, it is desired that the solid article comprises no more than 20%, preferably from 0% to 10%, more preferably from 0% to 5%, most preferably from 0% to 1%, by weight of said solid sheet article, of starch.

### 2. Surfactant System

The solid article of the present disclosure comprises one or more surfactants selected from the group consisting of anionic surfactants, nonionic surfactants, cationic surfactants, zwitterionic surfactants, amphoteric surfactants, polymeric surfactants or combinations thereof. Preferably, selected from the group consisting of anionic surfactants, nonionic surfactants, amphoteric surfactants, and a combination thereof. In a preferred embodiment, the surfactant system comprises linear alkylbenzene sulfonate and alkylethoxylated sulfate in a weight ratio of linear alkylbenzene sulfonate to alkylethoxylated sulfate of greater than 1, preferably from 10:1 to 3:1. Preferably, the surfactant system further comprises from 0.5 to 10% by weight of the article of C6-C20 linear or branched alkylalkoxylated alcohols (AA) having a weight average degree of alkoxylation ranging from 5 to 15, and combinations thereof. In another preferred embodiment, the surfactant system comprises amino oxide and alkylethoxylated sulfate, preferably in a weight ratio of from 8:1 to 1:1, more preferably in a weight ratio of from 6:1 to 2:1. Preferably, the surfactant system further comprises from 0.5 to 10% by weight of the article of C6-C20 linear or branched alkylalkoxylated alcohols (AA) having a weight average degree of alkoxylation ranging from 5 to 15, and combinations thereof.

One benefit of the present disclosure is that the solid article of the present disclosure is porous and may be characterized by a unique open cell foam (OCF) structure (as described hereinafter), which allows for incorporation of a high surfactant content while still providing fast dissolution. Consequently, highly concentrated cleaning compositions can be formulated into the solid articles of the present disclosure to provide a superior laundry experience to the consumers. Preferably, the solid article of the present disclosure comprises from about 30% to about 80%, preferably from about 40% to about 70%, more preferably from about 50% to about 65%, of the surfactant system by total weight of said solid article.

The surfactant as used herein may include both surfactants from the conventional sense (i.e., those providing a consumer-noticeable lathering effect) and emulsifiers (i.e., those that do not provide any lathering performance but are intended primarily as a process aid in making a stable foam structure). Examples of emulsifiers for use as a surfactant component herein include mono- and di-glycerides, fatty alcohols, polyglycerol esters, propylene glycol esters, sorbitan esters and other emulsifiers known or otherwise commonly used to stabilize air interfaces.

Non-limiting examples of anionic surfactants suitable for use herein include alkyl and alkyl ether sulfates, sulfated monoglycerides, sulfonated olefins, alkyl aryl sulfonates, primary or secondary alkane sulfonates, alkyl sulfosuccinates, acyl taurates, acyl isethionates, alkyl glycerylether sulfonate, sulfonated methyl esters, sulfonated fatty acids, alkyl phosphates, acyl glutamates, acyl sarcosinates, alkyl sulfoacetates, acylated peptides, alkyl ether carboxylates, acyl lactylates, anionic fluorosurfactants, sodium lauroyl glutamate, and combinations thereof.

One category of anionic surfactants particularly suitable for practice of the present disclosure include C₆-C₂₀ linear alkylbenzene sulphonate (LAS) surfactant. LAS surfactants are well known in the art and can be readily obtained by sulfonating commercially available linear alkylbenzenes. Exemplary C₁₀-C₂₀ linear alkylbenzene sulfonates that can be used in the present disclosure include alkali metal, alkaline earth metal or ammonium salts of C₁₀-C₂₀ linear alkylbenzene sulfonic acids, and preferably the sodium, potassium, magnesium and/or ammonium salts of C₁₁-C₁₈ or C₁₁-C₁₄ linear alkylbenzene sulfonic acids. More preferred are the sodium or potassium salts of C₁₂ and/or C₁₄ linear alkylbenzene sulfonic acids, and most preferred is the sodium salt of C₁₂ and/or C₁₄ linear alkylbenzene sulfonic acid, i.e., sodium dodecylbenzene sulfonate or sodium tetradecylbenzene sulfonate.

LAS provides superior cleaning benefit and is especially suitable for use in laundry detergent applications. It has been a surprising and unexpected discovery of the present disclosure that when polyvinyl alcohol having a specific weight average molecular weight (as described hereinabove) is used as the film-former and carrier, LAS can be used without adversely affecting the film-forming performance and stability of the overall composition. If present, the amount of LAS in the solid sheet article of the present disclosure may range from about 25% to about 70%, preferably from about 30% to about 65%, more preferably from about 40% to about 60%, by total weight of the solid article.

Another category of anionic surfactants suitable for practice of the present disclosure include sodium trideceth sulfates (STS) having a weight average degree of alkoxylation ranging from about 0.5 to about 5, preferably from about 0.8 to about 4, more preferably from about 1 to about 3, most preferably from about 1.5 to about 2.5. Trideceth is a 13-carbon branched alkoxylated hydrocarbon comprising, in one embodiment, an average of at least 1 methyl branch per molecule. STS used by the present disclosure may be include ST(EOxPOy)S, while EOx refers to repeating ethylene oxide units with a repeating number x ranging from 0 to 5, preferably from 1 to 4, more preferably from 1 to 3, and while POy refers to repeating propylene oxide units with a repeating number y ranging from 0 to 5, preferably from 0 to 4, more preferably from 0 to 2. It is understood that a material such as ST2S with a weight average degree of ethoxylation of about 2, for example, may comprise a significant amount of molecules which have no ethoxylate, 1 mole ethoxylate, 3 mole ethoxylate, and so on, while the distribution of ethoxylation can be broad, narrow or truncated, which still results in an overall weight average degree of ethoxylation of about 2. When polyvinyl alcohol having a specific weight average molecular weight (as described hereinabove) is used as the film-former and carrier, STS can be used without adversely affecting the film-forming performance and stability of the overall composition. If present, the amount of STS in the solid article of the present disclosure may range from about 25% to about 70%, preferably from about 30% to about 65%, more preferably from about 40% to about 60%, by total weight of the solid article.

Another category of anionic surfactants suitable for practice of the present disclosure include alkyl sulfates. These materials have the respective formulae ROSO₃M, wherein R is alkyl or alkenyl of from about 6 to about 20 carbon atoms, x is 1 to 10, and M is a water-soluble cation such as ammonium, sodium, potassium and triethanolamine. Preferably, R has from about 6 to about 18, preferably from about 8 to about 16, more preferably from about 10 to about 14, carbon atoms. Previously, non-aromatic and unalkoxylated C₆-C₂₀ linear or branched alkyl sulfates (AS) have been considered the surfactants of choice in solid sheet articles, due to its compatibility with low molecular weight polyvinyl alcohols (e.g., those with a weight average molecular weight of less more than 50,000 Daltons) in film-forming performance and storage stability. However, when polyvinyl alcohol having a higher weight average molecular weight (e.g., from about 50,000 to about 400,000 Daltons, preferably from about 60,000 to about 300,000 Daltons, more preferably from about 70,000 to about 200,000 Daltons, most preferably from about 80,000 to about 150,000 Daltons) is used as the film-former and carrier, surfactants such as LAS and/or STS with better cleaning performance and lower cost can be used at high levels in the solid article, without adversely affecting the film-forming performance and stability of the overall composition. Therefore, in a particularly preferred embodiment of the present disclosure, it is desirable to provide a solid article with no more than about 20%, preferably from 0% to about 10%, more preferably from 0% to about 5%, most preferably from 0% to about 1%, by weight of said solid article, of AS.

Another category of anionic surfactants suitable for practice of the present disclosure include C₆-C₂₀ linear or branched alkylalkoxy sulfates (AAS), especially those having a weight average degree of alkoxylation ranging from about 0.5 to about 10, preferably from about 1 to about 5, more preferably from about 2 to about 4. Among this category, linear or branched alkylethoxy sulfates (AES) having the respective formulae RO(C₂H₄O)ₓSO₃M are particularly preferred, wherein R is alkyl or alkenyl of from about 6 to about 20 carbon atoms, x is 1 to 10, and M is a water-soluble cation such as ammonium, sodium, potassium and triethanolamine. Preferably, R has from about 6 to about 18, preferably from about 8 to about 16, more preferably from about 10 to about 14, carbon atoms. The AES surfactants are typically made as condensation products of ethylene oxide and monohydric alcohol's having from about 6 to about 20 carbon atoms. Useful alcohols can be derived from fats, e.g., coconut oil or tallow, or can be synthetic. Lauryl alcohol and straight chain alcohol's derived from coconut oil are preferred herein. Such alcohol's are reacted with about 1 to about 10, preferably from about 3 to about 5, and especially about 3, molar proportions of ethylene oxide and the resulting mixture of molecular species having, for example, an average of 3 moles of ethylene oxide per mole of alcohol, is sulfated and neutralized. Highly preferred AAS (or preferably AES) are those comprising a mixture of individual compounds, said mixture having an average alkyl chain length of from about 10 to about 16 carbon atoms and an average degree of ethoxylation of from about 1 to about 4 moles of ethylene oxide. If present, the amount of AAS in the solid article of the present disclosure may range from about 2% to about 40%, preferably from about 5% to about 30%, more preferably from about 8% to about 12%, by total weight of the solid article.

Other suitable anionic surfactants include water-soluble salts of the organic, sulfuric acid reaction products of the general formula [R¹—SO₃-M], wherein R¹ is chosen from the group consisting of a straight or branched chain, saturated aliphatic hydrocarbon radical having from about 6 to about 20, preferably about 10 to about 18, carbon atoms; and M is a cation. Preferred are alkali metal and ammonium sulfonated C₁₀-18 n-paraffins. Other suitable anionic surfactants include olefin sulfonates having about 12 to about 24 carbon atoms. The α-olefins from which the olefin sulfonates are derived are mono-olefins having about 12 to about 24 carbon atoms, preferably about 14 to about 16 carbon atoms. Preferably, they are straight chain olefins.

Another class of anionic surfactants suitable for use in the fabric and home care compositions is the β-alkyloxy alkane sulfonates. These compounds have the following formula:

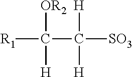

where R₁ is a straight chain alkyl group having from about 6 to about 20 carbon atoms, R₂ is a lower alkyl group having from about 1 (preferred) to about 3 carbon atoms, and M is a water-soluble cation as hereinbefore described.

Additional examples of suitable anionic surfactants are the reaction products of fatty acids esterified with isethionic acid and neutralized with sodium hydroxide where, for example, the fatty acids are derived from coconut oil; sodium or potassium salts of fatty acid amides of methyl tauride in which the fatty acids, for example, are derived from coconut oil. Still other suitable anionic surfactants are the succinamates, examples of which include disodium N-octadecylsulfosuccinamate; diammoniumlauryl sulfosuccinamate; tetrasodium N-(1,2-dicarboxyethyl)-N-octadecylsulfosuccinamate; diamyl ester of sodium sulfosuccinic acid; dihexyl ester of sodium sulfosuccinic acid; and dioctyl esters of sodium sulfosuccinic acid.

Nonionic surfactants that can be included into the solid article of the present disclosure may be any conventional nonionic surfactants, including but not limited to: alkyl alkoxylated alcohols, alkyl alkoxylated phenols, alkyl polysaccharides (especially alkyl glucosides and alkyl polyglucosides), polyhydroxy fatty acid amides, alkoxylated fatty acid esters, sucrose esters, sorbitan esters and alkoxylated derivatives of sorbitan esters, amine oxides, and the like. Preferred nonionic surfactants are those of the formula R¹ (OC₂H₄)ₙOH, wherein R¹ is a C₈-C₁₈ alkyl group or alkyl phenyl group, and n is from about 1 to about 80. Particularly preferred are C₈-C₁₈ alkyl ethoxylated alcohols having a weight average degree of ethoxylation from about 1 to about 20, preferably from about 5 to about 15, more preferably from about 7 to about 10, such as NEODOL® nonionic surfactants commercially available from Shell. Other non-limiting examples of nonionic surfactants useful herein include: C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched alkyl alkoxylates, BAEₓ, wherein x is from 1 to 30; alkyl polysaccharides, specifically alkyl polyglycosides; Polyhydroxy fatty acid amides; and ether capped poly(oxyalkylated) alcohol surfactants. Suitable nonionic surfactants also include those sold under the tradename Lutensol® from BASF.

In a preferred embodiment, the nonionic surfactant is selected from sorbitan esters and alkoxylated derivatives of sorbitan esters including sorbitan monolaurate (SPAN® 20), sorbitan monopalmitate (SPAN® 40), sorbitan monostearate (SPAN® 60), sorbitan tristearate (SPAN® 65), sorbitan monooleate (SPAN® 80), sorbitan trioleate (SPAN® 85), sorbitan isostearate, polyoxyethylene (20) sorbitan monolaurate (Tween® 20), polyoxyethylene (20) sorbitan monopalmitate (Tween® 40), polyoxyethylene (20) sorbitan monostearate (Tween® 60), polyoxyethylene (20) sorbitan monooleate (Tween® 80), polyoxyethylene (4) sorbitan monolaurate (Tween® 21), polyoxyethylene (4) sorbitan monostearate (Tween® 61), polyoxyethylene (5) sorbitan monooleate (Tween® 81), all available from Uniqema, and combinations thereof.

The most preferred nonionic surfactants for practice of the present disclosure include C₆-C₂₀ linear or branched alkylalkoxylated alcohols (AA) having a weight average degree of alkoxylation ranging from 5 to 15, more preferably C₁₂-C₁₄ linear ethoxylated alcohols having a weight average degree of alkoxylation ranging from 7 to 9. If present, the amount of AA-type nonionic surfactant(s) in the solid article of the present disclosure may range from about 2% to about 40%, preferably from about 5% to about 30%, more preferably from about 8% to about 12%, by total weight of the solid article.

In a preferred embodiment of the present disclosure, the solid article comprises from about 25% to about 70%, preferably from about 30% to about 65%, more preferably from about 40% to about 60%, by weight of said solid article, of a LAS, STS, or a combination thereof.

In a particularly preferred embodiment of the present disclosure, the flexible and dissolvable solid sheet article comprises, in addition to the first surfactant described hereinabove, from about 5% to about 40%, preferably from about 10% to about 30%, more preferably from about 15% to about 25%, by weight of said solid sheet article, of a second surfactant that is AAS, AA, or a combination thereof.

The solid article of the present disclosure may further include one or more amphoteric surfactants. Amphoteric surfactants suitable for use in the solid article of the present disclosure includes those that are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecyl-aminopropionate, sodium 3-dodecylaminopropane sulfonate, sodium lauryl sarcosinate, N-alkyltaurines such as the one prepared by reacting dodecylamine with sodium isethionate, and N-higher alkyl aspartic acids.

Zwitterionic surfactants suitable include those that are broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate. Such suitable zwitterionic surfactants can be represented by the formula:

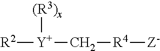

wherein R² contains an alkyl, alkenyl, or hydroxy alkyl radical of from about 8 to about 18 carbon atoms, from 0 to about 10 ethylene oxide moieties and from 0 to about 1 glyceryl moiety; Y is selected from the group consisting of nitrogen, phosphorus, and sulfur atoms; R³ is an alkyl or monohydroxyalkyl group containing about 1 to about 3 carbon atoms; X is 1 when Y is a sulfur atom, and 2 when Y is a nitrogen or phosphorus atom; R⁴ is an alkylene or hydroxyalkylene of from about 1 to about 4 carbon atoms and Z is a radical selected from the group consisting of carboxylate, sulfonate, sulfate, phosphonate, and phosphate groups.

Other zwitterionic surfactants suitable for use herein include betaines, including high alkyl betaines such as coco dimethyl carboxymethyl betaine, cocoamidopropyl betaine, cocobetaine, lauryl amidopropyl betaine, oleyl betaine, lauryl dimethyl carboxymethyl betaine, lauryl dimethyl alphacarboxyethyl betaine, cetyl dimethyl carboxymethyl betaine, lauryl bis-(2-hydroxyethyl) carboxymethyl betaine, stearyl bis-(2-hydroxypropyl) carboxymethyl betaine, oleyl dimethyl gamma-carboxypropyl betaine, and lauryl bis-(2-hydroxypropyl) alpha-carboxyethyl betaine. The sulfobetaines may be represented by coco dimethyl sulfopropyl betaine, stearyl dimethyl sulfopropyl betaine, lauryl dimethyl sulfoethyl betaine, lauryl bis-(2-hydroxyethyl) sulfopropyl betaine and the like; amidobetaines and amidosulfobetaines, wherein the RCONH(CH₂)₃ radical, wherein R is a C₁₁-C₁₇ alkyl, is attached to the nitrogen atom of the betaine are also useful.

### 3. Metalloprotease

The term “metalloprotease” is used herein in its conventional sense within the field of enzyme research and denotes a protease that requires a bound metal ion in order to be catalytically active. This is usually a zinc ion. The metalloproteases are preferably neutral metalloproteases, i.e. those that inter alia are active even at a neutral pH and require zinc ions for their catalytic effect. The molecular weight of proteases of this kind is usually in the range of from about 30 to about 40 kDa. The neutral metalloproteases are also referred to as “neutral metalloendopeptidases”.

In various embodiments, at least one metalloprotease is selected from metalloproteases from B. amyloliquefaciens, Bacillus, Geobacillus, Alicyclobacillus, Lactobacillus, Exiguobacterium, Brevibacillus, Paenibacillus, Herpetosiphon, Oceanobacillus, Shewanella, Clostridium, Staphylococcus, Flavobacterium, Stigmatella, Myxococcus, Methanosarcina, Chryseobacterium, Streptomyces, Kribbella, Janibacter, Nocardioides, Xanthamonas, Micromonospora, Burkholderia, Dehalococcoides, Croceibacter, Kordia, Microscilla, Thermoactinomyces, Chloroflexus, Listeria, Plesiocystis, Haliscomenobacter, Cytophaga, Hahella, Arthrobacter, Brachybacterium, Clavibacter, Microbacterium, Intrasporangium, Frankia, Meiothermus, Pseudomonas, Ricinus, Catenulispora, Anabaena, Nostoc, Halomonas, Chromohalobacter, Bordetella, Variovorax, Dickeya, Pectobacterium, Citrobacter, Enterobacter, Salmonella, Erwinia, Pantoea, Rahnella, Geodermatophilus, Gemmata, Xenorhabdus, Photorhabdus, Aspergillus, Neosartorya, Pyrenophora, Saccharopolyspora, Nectria, Gibberella, Metarhizium, Waddlia, Cyanothece, Cellulphaga, Providencia, Bradyrhizobium, Agrobacterium, Mucilaginibacter, Serratia, Sorangium, Streptosporangium, Renibacterium, Aeromonas, Chromobacterium, Moritella, Haliangium, Kangiella, Marinomonas, Vibrionales, Listonella, Salinivibrio, Photobacterium, Alteromonadales, Legionella, Teredinibacter, Reinekea, Hydrogenivirga, Pseudoalteromonas, Kribella, Thermoascus, Lysobacter, Achromobacter, Aeromonas and Streptomyces.

Examples of such metalloproteases and their variants include those described in: WO2015/158723 (SEQ ID NO:2), WO2015/193488 (SEQ ID NO:2), WO2014/029819 (SEQ ID NO: 2), WO2014/029820 (SEQ ID NO:2 and SEQ ID NO:4), WO2016/075078 (SEQ ID NO:2 and SEQ ID NO:4), WO2014/029821 (SEQ ID NO:2 and SEQ ID NO:4), WO2019/105675 (SEQ ID NO: 1), WO2019/142774, JP7057140 B2 (SEQ ID NO: 2, 4, 6, 8).

Preferably the protease is selected from the M4, M5, M7, M8, M23 or M35 family, more preferably an M4 metalloprotease, most preferably a neutral metalloprotease.

The term “M4 Metalloprotease Family” or “M4 Metalloprotease” or “M4” as used herein means a polypeptide falling into the M4 metalloprotease family according to Rawlings et al., Biochem. J., 290, 205-218 (1993) and as further described in MEROPS-(Rawlings et al., MEROPS: the peptidase database, Nucl Acids Res, 34 Database issue, D270-272, 2006). The M4 metalloproteases are neutral metalloproteases containing mainly endopeptidases. All peptidases in the family bind a single, catalytic zinc ion. M4 metalloprotease family members include the common HEXXH motif, where the histidine residues serve as zinc ligands and glutamate is an active site residue. M4 metalloproteases have a pH optimum mainly at neutral pH. The M4 metalloprotease family includes, e.g., Neutrase™ (Novozymes) (classified as MEROPS subclass M04.014), Thermolysin, Bacillolysin, vibriolysin, pseudolysin, Msp peptidase, coccolysin, aureolysin, vimelysin, lambda toxin neutral peptidase B, PA peptidase (Aeromonas-type), griselysin, stearolysin, Mprlll (Alteromonas sp. strain 0-7), pap6 peptidase, neutral peptidase (Thermoactinomyces-type), ZmpA peptidase (Burkholderia sp.), zpx peptidase, PrtS peptidase (Photorhabdus luminescens), protealysin, ZmpB peptidase (Burkholderia sp.). The M4 metalloprotease family of polypeptides have been further characterized and presently includes, according to MEROPS, at least twenty-two subclasses for which a distinct MEROPS ID (i.e., an identifier of the formula M04.xxx) has been assigned, as well as non-peptidase homologues and unassigned peptidases.

The term “M5 Metalloprotease Family” or “M5 Metalloprotease” or “M5” or “mycolysin family” as used herein means a polypeptide falling into the M5 metalloprotease family according to Rawlings et al., Biochem. J., 290, 205-218 (1993) and as further described in MEROPS-(Rawlings et al., MEROPS: the peptidase database, Nucl Acids Res, 34 Database issue, D270-272, 2006).

The term “M7 Metalloprotease Family” or “M7 Metalloprotease” or “M7” or “snapalysin family” as used herein means a polypeptide falling into the M7 metalloprotease family according to Rawlings et al., Biochem. J., 290, 205-218 (1993) and as further described in MEROPS—(Rawlings et al., MEROPS: the peptidase database, Nucl Acids Res, 34 Database issue, D270-272, 2006). The protease family M7 contains a metalloendopeptidase, snapalysin.

The term “M8 Metalloprotease Family” or “M8 Metalloprotease” or “M8” or “leishmanolysin family” as used herein means a polypeptide falling into the M8 metalloprotease family according to Rawlings et al., Biochem. J., 290, 205-218 (1993) and as further described in MEROPS—(Rawlings et al., MEROPS: the peptidase database, Nucl Acids Res, 34 Database issue, D270-272, 2006).

The term “M23 Metalloprotease Family” as used herein means a polypeptide falling into the M23 metalloprotease family according to Proteolysis in Cell Function, pp 13-21, IOS Press, Amsterdam (1997), Rawlings et al., Biochem. J., 290, 205-218 (1993) and as further described in MEROPS—(Rawlings et al., MEROPS: the peptidase database, Nucl Acids Res, 34 Database issue, D270-272, 2006). The M23 family includes stapholysin and lysostaphin.

The term “M35 Metalloprotease Family” or “M 35 Metalloprotease” or “M 35” or “deuterolysin family” as used herein means a polypeptide falling into the M35metalloprotease family according to Proteolysis in Cell Function, pp 13-21, IOS Press, Amsterdam (1997), Rawlings et al., Biochem. J., 290, 205-218 (1993) and as further described in MEROPS—(Rawlings et al., MEROPS: the peptidase database, Nucl Acids Res, 34 Database issue, D270-272, 2006).

Preferred metalloproteases include thermolysin, matrix metalloproteinases and those metalloproteases derived from Bacillus subtilis, Bacillus thermoproteolyticus, Geobacillus stearothermophilus or Geobacillus sp., or Bacillus amyloliquefaciens, as described in US PA 2008/0293610A1, or Paenibacillus hunanensis. A specially preferred metalloprotease belongs to the M4 family according to Rawlings et al., Biochem. J., 290, 205-218 (1993) and as further described in MEROPS—(Rawlings et al., MEROPS: the peptidase database, Nucl Acids Res, 34 Database issue, D270-272, 2006). Specially preferred for use herein are metalloproteases derived from Paenibacillus hunanensis.

In one aspect, suitable metalloproteases are the neutral metalloprotease variants described in WO2007/044993, WO2009/058661 and US20140315775. In one aspect the protease is a variant having at least 80%, or 85% or 90% or 95% or 96% or 97% or 98% or 99% or even 100% identity to SEQ ID NO:18 of WO2007/044993, including those with substitutions at one or more of the following positions versus SEQ ID NO:18 of WO2007/044993: T004C, T004E, T004H, T004I, T004K, T004L, TO04M, T004N, T004P, T004R, T004S, T004V, T004W, T004Y, G012D, G012E, G012I, G012K, G012L, G012M, G012Q, G012R, G012T, G012V, G012W, K013A, K013C, K013D, K013E, K013F, K013G, K013H, K013I, K013L, K013M, K013N, K013Q, K013S, K013T, K013V, K013Y, T014F, TO14G, T014H, T014I, T014KJ014L, T014M, T014P, T014Q, TO14R, T014S, T014V, T014W, T014Y, S023A, S023D, S023F, S023G, S023I, S023K, S023L, S023M, S023N, S023P, S023Q, S023R, S023S, S023T, S023V, S023W, S023Y, G024A, G024D, G024F, G024G, G024H, G024I, G024K, G024L, G024M, G024N, G024P, G024R, G024S, G024T, G024V, G024W, G024Y, K033H, Q045C, Q045D, Q045E, Q045F, Q045H, Q045I, Q045K, Q045L, Q045M, Q045N, Q045P, Q045R, Q045T, Q045W, N046A, N046C, N046E, N046F, N046G, N046H, N046I, N046K, N046L, N046M, N046P, N046Q, N046R, N046S, N046T, N046V, N046W, N046Y, R047E, R047K, R047L, R047M, R⁴⁷Q, R047S, R047T, Y049A, Y049C, Y049D, Y049E, Y049F, Y049H, Y049I, Y049K, Y049L, Y049N, Y049R, Y049S, Y049T, Y049V, Y049W, N050D, N050F, N050G, N050H, N050I, N050K, N050L, N050M, N050P, N050Q, N050R, N050W, N050Y, T054C, T054D, T054E, T054F, TO54G, TO54H, TO54I TO54K, TO54L, T054M, T054N, TO54P, T054Q, TO54R, TO54S, T054V, T054W, T054Y, S058D, S058H, S058I, S058L, S058N, S058P, S058Q, T059A, T059C, T059E, TO59G, T059H, TO59I, TO59K, TO59L T059M, T059N, TO59P, T059Q, TO59R, TO59S, T059V, T059W, T060D, TO60F, TO60I, T060K, TO60L, T060N, T060Q, T060R, T060V, T060W, T060Y, T065C, T065E, T065F, TO65H, TO65I, T065K, TO65L, TO65M, T065P, T065Q, T065R, T065V, T065Y, S066C, S066D, S066E, S066F, S066H, S066I, S066K, S066L, S066N, S066P, S066Q, S066R, S066T, S066V, S066W, S066Y, Q087A, Q087D, Q087E, Q087H, Q087I, Q087K, Q087L, Q087M, Q087N, Q087R, Q087S, Q087T, Q087V, Q087W, N090C, N090D, N090E, N090F, N090G, N090H, N090K, N090L, N090R, N090T, N096G, N096H, N096K, N096R, K097H, K097Q, K097W, K100A, K100D, K100E1 K100F, K100H, K100N, K100P, K100Q, K100R, K100S, K100V, K100Y, R110A, R110C, R110E, R110H, R110K, R110L, R110M, R110N, R110Q, R110S, R110Y, D119E, D119H, D119I, D119L, D119Q, D119R, D119S, D119T, D119V, D119W, G128C, G128F, G128H, G128K, G128L, G128M, G128N, G128Q, G128R, G128W, G128Y, S129A, S129C, S129D, S129F, S129G, S129H, S129I, S129K, S129L, S129M, S129Q, S129R, S129T, S129V, S129W, S129Y, F130I, F130K, F130L, F130M, F130Q, F130R, F130T, F130V, F130Y, S135P, G136I, G136L, G136P, G136V, G136W, G136Y, S137A, M138I, M138K, M138L, M138Q, M138V, D139A, D139C, D139E, D139G, D139H, D139I, D139K, D139L, D139M, D139P, D139R, D139S, D139V, D139W, D139Y, V140C, Q151I, E152A, E152C, E152D, E152F, E152G, E152H, E152L, E152M, E152N, E152R, E152S, E152W, N155D, N155K, N155Q, N155R, D178A, D178C, D178G, D178H, D178K, D178L, D178M, D178N, D178P, D178Q, D178R, D178S, D178T, D178V, D178W, D178Y, T179A, T179F, T179H, T179I, T179K, T179L, T179M, T179N, T179P, T179Q, T179R, T179S, T179V, T179W, T179Y, E186A, E186C, E186D, E186G, E186H, E186K, E186L, E186M, E186N, E186P, E186Q, E186R, E186S, E186T, E186V, E186W, E186Y, V190H, V190I, V190K, V190L, V190Q, V190R, S191F, S191G, S191H, S191I, S191K, S191L, S191N, S191Q, S191R, S191W, L198M, L198V, S199C, S199D, S199E, S199F, S199I, S199K, S199L, S199N, S199Q, S199R, S 199V, Y204H, Y204T, G205F, G205H, G205L, G205M, G205N, G205R, G205S, G205Y, K211A, K211C, K211D, K211G, K211M, K211N, K211Q, K211R, K211S, K211T, K211V, K214A, K214C, K214E, K214I, K214L, K214M, K214N, K214Q, K214R, K214S, K214V, L216A, L216C, L216F, L216H, L216Q, L216R, L216S, L216Y, N218K, N218P, T219D, D220A, D220E, D220H, D220K, D220N, D220P, A221D, A221E, A221F, A221I, A221K, A221L, A221M, A221N, A221S, A221V, A221Y, G222C, G222H, G222N, G222R, Y224F, Y224H, Y224N, Y224R, T243C, T243G, T243H, T243I, T243K, T243L, T243Q, T243R, T243W, T243Y, K244A, K244C, K244D, K244E, K244F, K244G, K244L, K244M, K244N, K244Q, K244S, K244T, K244V, K244W, K244Y, V260A, V260D, V260E, V260G, V260H, V260I, V260K, V260L, V260M, V260P, V260Q, V260R V260S, V260T, V260W, V260Y, Y261C, Y261F, Y261I, Y261L, T263E, T263F, T263H, T263I, T263L, T263M, T263Q, T263V, T263W, T263Y, S265A, S265C, S265D, S265E, S265K, S265N, S265P, S265Q, S265R, S265T, S265V, S265W, K269E, K269F, K269G, K269H, K269I, K269L, K269M, K269N, K269P, K269Q, K269S, K269T, K269V, K269W, K269Y, A273C, A273D, A273H, A273I, A273K, A273L, A273N, A273Q, A273R, A273Y, R280A, R280C, R280D, R280E, R280F, R280G, R280H, R280K, R280L, R280M, R280S, R280T, R280V, R280W, R280Y, L282F, L282G, L282H, L282I, L282K, L282M, L282N, L282Q, L282R, L282V, L282Y, S285A, S285C, S285D, S285E, S285K, S285P, S285Q, S285R, S285W, Q286A, Q286D, Q286E, Q286K, Q286P, Q286R, A289C, A289D, A289E, A289K, A289L, A289R, A293C, A293R, N296C, N296D, N296E, N296K, N296R, N296V, A297C, A297K, A297N, A297Q, A297R and G299N.

In some preferred embodiments, the metalloprotease is a metalloprotease variant having a sequence identity of at least 80%, or 85% or 90% or 95% or 96% or 97% or 98% or 99% or even 100% identity to SEQ ID NO:18 of WO2007/044993, including those with substitutions at one or more of the following positions SEQ ID NO:1 (SEQ ID NO:18 of WO2007/044993): S129I, S129V, S129L, F130L, M138I, M138L, V190I, V190L, D220E and D220P, particularly preferred S129I, F130L, M138L, V190I, D220P (SEQ ID NO:20 in WO2009/058661).

Further suitable metalloproteases are derived from a member of the order Bacillales; family Bacillaceae, Paenibacillaceae, Geobacillus, Brevibacillus, Paenibacillus, Alicyclobacillaceae, Lactobacillus, Exiguobacterium spp. as described in WO2014194034 and WO2014194117. In one aspect the protease is derived from Paenibacillus hunanensis described in WO2014194034. In one aspect the protease is having at least 80%, or 85% or 90% or 95% or 96% or 97% or 98% or 99% or even 100% identity to SEQ ID NO:1 (SEQ ID NO: 33 of WO2014194034).

The neutral metalloproteases of the present disclosure are also referred to as “neutral metalloendopeptidases” and include the enzymes in class EC 3.4.24.

Suitable commercially available metalloprotease enzymes include those sold under the trade names Neutrase® by Novozymes A/S (Denmark), the Corolase® range including Corolase® 8000 and Corolase® 7089 from AB Enzymes, Protex 14L and Protex 15L from IFF (Palo Alto, Calif.), those sold as thermolysin from Sigma and the Thermoase range (PC10F and C100) and thermolysin enzyme from Amano enzymes.

Preferred levels of metalloprotease in the product include from about 0.05 to about 10 mg, more preferably from about 0.5 to about 7 mg and especially from about 1 to about 6 mg of active metalloprotease/g of the article.

### 4. Serine Proteases

Suitable proteases for use in combination with metalloproteases are serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
i) subtilisins (EC 3.4.21.62), especially those derived from Bacillus, such as Bacillus sp., B. lentus, B. alkalophilus, B. subtilis, B. amyloliquefaciens, B. gibsonii, B. akibaii, Bacillus Clausii and B. clarkii described in WO2004067737, WO2015091989, WO2015091990, WO2015024739, WO2015143360, U.S. Pat. No. 6,312,936 B1, U.S. Pat. Nos. 5,679,630, 4,760,025, WO03/055974, WO03/054185, WO03/054184, WO2017/215925, DE102006022216A1, WO2015089447, WO2015089441, WO2016066756, WO2016066757, WO2016069557, WO2016069563, WO2016069569, WO2016174234, WO2017/089093, WO2020/156419, WO2016/183509. Specifically, mutations S9R, A15T, V66A, A188P, V199I, N212D, Q239R, N255D, X9E, X200L, X256E, X9R, X19L, X60D (Savinase numbering system)
ii) subtilisins from B. Pumilus such as the ones described in DE102006022224A1, WO2020/221578, WO2020/221579, WO2020/221580, including variants comprising amino acid substitutions in at least one or more of the positions selected from 9, 130, 133, 144, 224, 252, 271 (BPN′ numbering system).
iii) trypsin-type or chymotrypsin-type proteases, such as trypsin (e.g., of porcine or bovine origin), including the Fusarium protease described in WO 89/06270 and the chymotrypsin
iv) proteases derived from Cellumonas described in WO 05/052161 and WO 05/052146
v) proteases having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.
Specially preferred for use herein serine protease is a variant, wherein said variant has at least 90%, preferably at least 95%, preferably at least 98%, preferably 100% amino acid identity with Bacillus lentus subtilisin GG36 protease comprising the amino acid sequence shown in SEQ ID NO:3.

The most preferred serine protease for use herein is a variant, wherein said variant has at least 90%, preferably at least 95% amino acid identity with Bacillus lentus subtilisin GG36 protease comprising the amino acid sequence shown in SEQ ID NO:3 and said variant comprises an amino acid sequence comprising one of the combinations of amino acid substitutions: T022A-S103A-V104 IN116L-G159D-S188D-A232V-Q245R-N248D-E271F, T022A-S101G-V104I-N116L-G159D-S188D-A232V-Q245R-N248D-E271F, T022A-S101G-S103A-V104I-N116L-S188D-A232V-Q245R-N248D-E271F, T022A-S101G-S103A-V104I-N116L-G159D-S188D-Q245R-N248D-E271F, T022A-S101G-S103A-V104I-N116L-G159D-S188D-A232V-N248D-E271F, T022A-S101G-S103A-V104I-N116L-G159D-S188D-A232V-Q245R-E271F, T022A-S101G-S103A-V104I-N116L-G159D-S188D-A232V-Q245R-N248D-E271F, T022A-T033S-S101G-S103A-V104I-N116L-G159D-S188D-T213A-A232V-Q245R-N248D-E271F, T022A-V068A-S101G-S103A-V104 IN116L-G159D-S188D-T213A-A232V-Q245R-N248D-E271F, T022A-S101G-S103A-V104 IN116L-G159D-S188D-T213A-A232V-Q245R-N248D-E271F, T022A-S101G-S103A-V104 IN116L-S128L-G159D-S188D-A232V-Q245R-N248D-E271F, T022A-V068A-S101G-S103A-V104I-N116L-G159D-S188D-A232V-Q245R-N248D-E271F, T022A-S101G-S103A-V104I-N116L-G159D-S188D-A232V-Q245R-N248D, T022A-S101G-S103A-V104I-N116L-S128L-G159D-S188D-T213A-A232V-Q245R-N248D-E271F, T022A-N062D-S101G-S103A-V104I-N116L-G159D-S188D-T213A-A232V-Q245R-N248D-E271F, T022A-T033S-S101G-S103A-V104I-N116L-S128L-G159D-S188D-A232V-Q245R-N248D-E271F, T022A-T033S-S101G-S103A-V104I-N116L-G159D-S188D-A232V-Q245R-N248D-E271F, T022A-T033S-S101G-S103A-V104I-N116L-S128L-G159D-S188D-T213A-A232V-Q245R-N248D-E271F, wherein amino acid positions of the subtilisin variant are numbered according to the numbering of corresponding amino acid positions in the amino acid sequence of Bacillus amyloliquefaciens subtilisin BPN′ shown in SEQ ID NO:4, preferably said variant comprising a combination of amino acid substitutions selected from T022A-S103A-V104I-N116L-G159D-S188D-A232V-Q245R-N248D-E271F, T022A-S101G-V104I-N116L-G159D-S188D-A232V-Q245R-N248D-E271F, T022A-S101G-S103A-V104I-N116L-S188D-A232V-Q245R-N248D-E271F, T022A-S101G-S103A-V104I-N116L-G159D-S188D-Q245R-N248D-E271F, T022A-S101G-S103A-V104I-N116L-G159D-S188D-A232V-N248D-E271F, T022A-S101G-S103A-V104I-N116L-G159D-S188D-A232V-Q245R-E271F, T022A-S101G-S103A-V104I-N116L-G159D-S188D-A232V-Q245R-N248D-E271F, T022A-T033S-S101G-S103A-V104I-N116L-G159D-S188D-T213A-A232V-Q245R-N248D-E271F, T022A-V068A-S101G-S103A-V104I-N116L-G159D-S188D-T213A-A232V-Q245R-N248D-E271F, T022A-S101G-S103A-V104I-N116L-G159D-S188D-T213A-A232V-Q245R-N248D-E271F, T022A-S101G-S103A-V104I-N116L-S128L-G159D-S188D-A232V-Q245R-N248D-E271F, T022A-V068A-S101G-S103A-V104I-N116L-G159D-S188D-A232V-Q245R-N248D-E271F, and wherein amino acid positions of the subtilisin variant are numbered according to the numbering of corresponding amino acid positions in the amino acid sequence of Bacillus amyloliquefaciens subtilisin BPN′ shown in SEQ ID NO: 4.

Especially preferred said variant has at least 90%, preferably at least 95% amino acid identity with Bacillus lentus subtilisin GG36 protease comprising the amino acid sequence shown in SEQ ID NO: 3 and said variant comprises an amino acid sequence comprising one of the combinations of amino acid substitutions: T022A-S101G-S103A-V104I-N116L-G159D-S188D-A232V-Q245R-N248D-E271F, T022A-S101G-S103A-V104I-N116L-G159D-S188D-A232V-Q245R-N248D-E271F and T22R+S101G+S103A+V104I+A232V+Q245R and wherein amino acid positions of the subtilisin variant are numbered according to the numbering of corresponding amino acid positions in the amino acid sequence of Bacillus amyloliquefaciens subtilisin BPN′ shown in SEQ ID NO:4.

Other proteases suitable for the detergent of the present disclosure are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: S9R, A15T, V68A, N76D, N87S, S99D, S99SD, S99A, S101G, S101M, S103A, V104N/I, G118V, G118R, S128L, P129Q, S130A, Y167A, R170S, A194P, V205I, Q206L/D/E, Y209W, M222S, Q245R and/or M222S.

Other suitable protease is selected from the group of proteases comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+S130A
(ii) S101M+G118V+S128L+P129Q+S130A
(iii) N76D+N87R+G118R+S128L+P129Q+S130A+S188D+N248R
(iv) N76D+N87R+G118R+S128L+P129Q+S130A+S188D+V244R
(v) N76D+N87R+G118R+S128L+P129Q+S130A
(vi) V68A+N87S+S101G+V104N
(vii) S99AD
(viii) S9R+A15T+V68A+N218D+Q245R

Other suitable protease is a subtilase variant derived from B. amyloliquefaciens (BPN′), as described in WO2011/072117. Especially useful BPN′ variant comprises mutation in one or more of the following positions: X003Q, X006W, X022Y, X024K, X024Q, X024G, X033T, X045V, X053G, X055P, S063T, X076D, X078N, X087D, X101N, X109Q, X118R, X128A, X128S, X145R, X166Q, X169A, X162Q, X182Q, X183N, S183T, X204Q, X206Y, X217Q, Y217L, X218S, X222Q, X248A or X254A; (in BPN′ numbering system).

Suitable commercially available additional protease enzymes include:
i) those sold under the trade names Alcalase®, Savinase®, Primase®, Durazym®, Polarzyme®, Kannase®, Liquanase®, Liquanase Ultra®, Savinase Ultra®, Liquanase® Evity®, Savinase® Evity®, Ovozyme®, Neutrase®, Everlase®, Coronase®, Blaze®, Blaze Ultra®, Blaze® Evity®, Blaze® Exceed, Blaze® Pro, Esperase®, Progress® Uno, Progress® Excel, Progress® Key, Ronozyme®, Vinzon® and Het Ultra® by Novozymes A/S (Denmark);
those sold under the tradename Maxatase®, Maxacal®, Maxapem®, Properase®, Purafect®, Purafect Prime®, Purafect Ox®, FN3®, FN4®, Excellase®, Ultimase® and Purafect OXP®, Preferenz® by IFF (formerly Dupont);
ii) those sold under the tradename Opticlean® and Optimase® by Solvay Enzymes;
those available from Henkel/Kemira, namely BLAP (sequence shown in FIG. 29 of U.S. Pat. No. 5,352,604 with the following mutations S99D+S101R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D); and can comprise a further mutation 101E/D, S156D, L262E, 206A/L/S/T/, 209K/V/W, 215W, 216N/S/T; and
iii) those sold under the tradename and Lavergy®, Lavergy® Pro, Lavergy® C Bright from BASF.

Especially preferred for use herein in combination with the metalloprotease of the present disclosure are commercial proteases selected from the group consisting of Properase®, Blaze®, Ultimase®, Everlase®, Savinase®, Excellase®, Blaze Ultra®, BLAP and BLAP variants (Lavergy® Pro).

Preferred levels of protease in the product of the present disclosure include from about 0.05 to about 10 mg, more preferably from about 0.5 to about 7 mg and especially from about 1 to about 6 mg of active protease/g of the article.

### 5. Plasticizers

In a preferred embodiment of the present disclosure, the solid article of the present disclosure further comprises a plasticizer, preferably in the amount ranging from about 0.1% to about 25%, preferably from about 0.5% to about 20%, more preferably from about 1% to about 15%, most preferably from 2% to 12%, by total weight of said solid article.

Suitable plasticizers for use in the present disclosure include, for example, polyols, copolyols, polycarboxylic acids, polyesters, dimethicone copolyols, and the like.

Examples of useful polyols include, but are not limited to: glycerin, diglycerin, ethylene glycol, polyethylene glycol (especially 200-600), propylene glycol, butylene glycol, pentylene glycol, glycerol derivatives (such as propoxylated glycerol), glycidol, cyclohexane dimethanol, hexanediol, 2,2,4-trimethylpentane-1,3-diol, pentaerythritol, urea, sugar alcohols (such as sorbitol, mannitol, lactitol, xylitol, maltitol, and other mono- and polyhydric alcohols), mono-, di- and oligo-saccharides (such as fructose, glucose, sucrose, maltose, lactose, high fructose corn syrup solids, and dextrins), ascorbic acid, sorbates, ethylene bisformamide, amino acids, and the like.

Examples of polycarboxylic acids include, but are not limited to citric acid, maleic acid, succinic acid, polyacrylic acid, and polymaleic acid.

Examples of suitable polyesters include, but are not limited to, glycerol triacetate, acetylated-monoglyceride, diethyl phthalate, triethyl citrate, tributyl citrate, acetyl triethyl citrate, acetyl tributyl citrate.

Examples of suitable dimethicone copolyols include, but are not limited to, PEG-12 dimethicone, PEG/PPG-18/18 dimethicone, and PPG-12 dimethicone.

Other suitable platicizers include, but are not limited to, alkyl and allyl phthalates; napthalates; lactates (e.g., sodium, ammonium and potassium salts); sorbeth-30; urea; lactic acid; sodium pyrrolidone carboxylic acid (PCA); sodium hyraluronate or hyaluronic acid; soluble collagen; modified protein; monosodium L-glutamate; alpha & beta hydroxyl acids such as glycolic acid, lactic acid, citric acid, maleic acid and salicylic acid; glyceryl polymethacrylate; polymeric plasticizers such as polyquaterniums; proteins and amino acids such as glutamic acid, aspartic acid, and lysine; hydrogen starch hydrolysates; other low molecular weight esters (e.g., esters of C₂-C₁₀ alcohols and acids); and any other water soluble plasticizer known to one skilled in the art of the foods and plastics industries; and mixtures thereof.

Particularly preferred examples of plasticizers include glycerin, ethylene glycol, polyethylene glycol, propylene glycol, and mixtures thereof. Most preferred plasticizer is glycerin.

### 6. Additional Ingredients

In addition to the above-described ingredients, the solid article of the present disclosure may comprise one or more additional ingredients. Such one or more additional ingredients may be selected from the group consisting of fabric care actives.

Suitable fabric care actives include but are not limited to: organic solvents (linear or branched lower C₁-C₈ alcohols, diols, glycerols or glycols; lower amine solvents such as C₁-C₄ alkanolamines, and mixtures thereof; more specifically 1,2-propanediol, ethanol, glycerol, monoethanolamine and triethanolamine), carriers, hydrotropes, builders, chelants, dispersants, additional enzymes and enzyme stabilizers, catalytic materials, bleaches (including photobleaches) and bleach activators, perfumes (including encapsulated perfumes or perfume microcapsules), colorants (such as pigments and dyes, including hueing dyes), brighteners, dye transfer inhibiting agents, clay soil removal/anti-redeposition agents, structurants, rheology modifiers, suds suppressors, processing aids, fabric softeners, anti-microbial agents, and the like.

The solid article of the present disclosure may further comprise other optional ingredients that are known for use or otherwise useful in compositions, provided that such optional materials are compatible with the selected essential materials described herein, or do not otherwise unduly impair product performance.

Following are detailed descriptions on the processes of making the above-described porous solid articles.

### III. Overview of Processes for Making Sheets

The solid article of the present disclosure can be formed from one or more sheets by any suitable sheet-forming process. Preferably, such sheet-forming process includes an aeration step that leads to formation of porous structures, more preferably open-celled foam (OCF) structures, in the resulting solid articles.

For example, WO2010077627 discloses a batch process for forming porous sheets with OCF structures characterized by a Percent Open Cell Content of from about 80% to 100%, which functions to improve dissolution. Specifically, a pre-mixture of raw materials is first formed, which is vigorously aerated and then heat-dried in batches (e.g., in a convection oven or a microwave oven) to form the porous sheets with the desired OCF structures. Although such OCF structures significantly improve the dissolution rate of the resulting porous sheets, there is still a visibly denser and less porous bottom region with thicker cell walls in such sheets. Such high-density bottom region may negatively impact the flow of water through the sheets and thereby may adversely affect the overall dissolution rate of the sheets. When a plurality of such sheets is stacked together to form a multilayer structure, the “barrier” effect of multiple high-density bottom regions is especially augmented.

For another example, WO2012138820 discloses a similar process as that of WO2010077627, except that continuous drying of the aerated wet pre-mixture is achieved by using, e.g., an impingement oven (instead of a convection oven or a microwave oven). The OCF sheets formed by such a continuous drying process are characterized by improved uniformity/consistency in the pore structures across different regions thereof. Unfortunately, there are still rate-limiting factors in such OCF sheets, such as a top surface with relatively smaller pore openings and a top region with relatively smaller pores (i.e., a crust-like top region), which may negatively impact the flow of water therethrough and slow down the dissolution thereof.

During the drying step in the above-described processes, the OCF structures are formed under simultaneous mechanisms of water evaporation, bubble collapse, interstitial liquid drainage from the thin film bubble facings into the plateau borders between the bubbles (which generates openings between the bubbles and forms the open cells), and solidification of the pre-mixture. Various processing conditions may influence these mechanisms, e.g., solid content in the wet pre-mixture, viscosity of the wet pre-mixture, gravity, and the drying temperature, and the need to balance such processing conditions so as to achieve controlled drainage and form the desired OCF structures.

The direction of thermal energy employed (i.e., the heating direction) during the drying step may also have a significant impact on the resulting OCF structures, in addition to the above-mentioned processing conditions. For example, if the thermal energy is applied in a non-directional matter (i.e., there is no clear heating direction) during the drying step, or if the heating direction is substantially aligned with the gravitational direction (i.e., with an offset angle of less than 90° in between) during most of the drying step, the resulting flexible, porous, dissolvable solid sheet tends to have a top surface with smaller pore openings and greater pore size variations in different regions along the direction across its thickness. In contrast, when the heating direction is offset from the gravitation direction (i.e., with an offset angle of 90° or more therebetween) during most of the drying step, the resulting solid sheet may have a top surface with larger pore openings and reduced pore size variations in different regions along the direction across the thickness of such sheet. Correspondingly, the latter sheets are more receptive to water flowing through and are therefore more dissolvable than the former sheets.

While not being bound by any theory, it is believed that the alignment or misalignment between the heating direction and the gravitational direction during the drying step and the duration thereof may significantly affect the interstitial liquid drainage between the bubbles, and correspondingly impacting the pore expansion and pore opening in the solidifying pre-mixture and resulting in solid sheets with very different OCF structures. Such differences are illustrated by FIGS. 1-5 in WO 2020/147008 A1 and corresponding text in pages 23 to 27.

### IV. Process of Making Solid Sheets

The solid sheets can be made by the steps of: (a) forming a wet pre-mixture containing raw materials (e.g., the PVA polymer or copolymer, the surfactants, and optionally the plasticizer and any other active ingredients) dissolved or dispersed in water or a suitable solvent, which is characterized by a viscosity of from about 1,000 cps to about 25,000 cps measured at about 40 °C and 1 s⁻¹; (b) aerating said wet pre-mixture (e.g., by introducing a gas into the wet slurry) to form an aerated wet pre-mixture; (c) forming said aerated wet pre-mixture into a sheet having opposing first and second sides; and (d) drying said formed sheet for a drying time of from 1 minute to 60 minutes at a temperature from 70 °C to 200 °C, preferably along a heating direction that forms a temperature gradient decreasing from the first side to the second side of said formed sheet, wherein the heating direction is substantially offset from the gravitational direction for more than half of the drying time, i.e., the drying step is conducted under heating along a mostly “anti-gravity” heating direction. Such a mostly “anti-gravity” heating direction can be achieved by various means, which include but are not limited to the bottom conduction-based heating/drying arrangement and the rotary drum-based heating/drying arrangement. Each step is described in more detail in WO 2020/147008 A1, page 28 to 37.

### V. Physical Characteristics of Solid Sheets

The solid sheet formed by the above-described processing steps, especially by using an antigravity heating/drying arrangement, may be characterized by improved pore structures that allows easier water ingress into the sheet and faster dissolution of the sheet in water. Such improved pore structures can be readily achieved by adjusting various processing conditions as described hereinabove.

In general, such solid sheet may be characterized by: (i) a Percent Open Cell Content of from about 80% to 100%, preferably from about 85% to 100%, more preferably from about 90% to 100%, as measured by the Test 3 hereinafter; and (ii) an Overall Average Pore Size of from about 100 μm to about 2000 μm, preferably from about 150 μm to about 1000 μm, more preferably from about 200 μm to about 600 μm, as measured by the Micro-CT method described in Test 2 hereinafter. The Overall Average Pore Size defines the porosity of the OCF structure of the present disclosure. The Percent Open Cell Content defines the interconnectivity between pores in the OCF structure of the present disclosure. Interconnectivity of the OCF structure may also be described by a Star Volume or a Structure Model Index (SMI) as disclosed in WO2010077627 and WO2012138820.

The solid article of the present disclosure has opposing top and bottom surfaces, while its top surface is preferably characterized by a Surface Average Pore Diameter that is greater than about 100 μm, more preferably greater than about 110 μm, still more preferably greater than about 120 μm, still more preferably greater than about 130 μm, most preferably greater than about 150 μm, as measured by the SEM method described in Test 1 hereinafter. When comparing with solid sheets formed by the non-anti-gravity heating/drying arrangements (e.g., the convection-based, the microwave-based, or the impingement oven-based arrangements), the solid sheet formed by the anti-gravity heating/drying arrangement (e.g., the bottom conduction-based or the rotary drum based arrangements) has a significantly larger Surface Average Pore Diameter at its top surface (as demonstrated by FIGS. 6A-6B, which are described in detail in Example 2 of WO2020/147008), because under the antigravity heating, the top surface of the formed sheet of aerated wet pre-mixture is the last to dry/solidify, and the air bubbles near the top surface has the longest time to expand and form larger pore openings at the top surface.

Still further, the solid sheet formed by the anti-gravity heating/drying arrangement described herein may be characterized by a more uniform pore size distribution between different regions along its thickness direction, in comparison with the sheets formed by the non-anti-gravity heating/drying arrangements. Specifically, the solid sheet formed by the anti-gravity heating/drying arrangement comprises a top region adjacent to the top surface, a bottom region adjacent to the bottom surface, and a middle region therebetween, while the top, middle, and bottom regions all have the same thickness. Each of the top, middle and bottom regions of such solid sheet is characterized by an Average Pore Size, while the ratio of Average Pore Size in the bottom region over that in the top region (i.e., bottom-to-top Average Pore Size ratio) is from about 0.6 to about 1.5, preferably from about 0.7 to about 1.4, preferably from about 0.8 to about 1.3, more preferably from about 1 to about 1.2. In comparison, a solid sheet formed by the impingement oven-based heating/drying arrangement may have a bottom-to-top Average Pore Size ratio of more than 1.5, typically about 1.7-2.2 (as demonstrated in Example 2 hereinafter). Moreover, the solid sheet formed by the anti-gravity heating/drying arrangement may be characterized by a bottom-to-middle Average Pore Size ratio of from about 0.5 to about 1.5, preferably from about 0.6 to about 1.3, more preferably from about 0.8 to about 1.2, most preferably from about 0.9 to about 1.1, and a middle-to-top Average Pore Size ratio of from about 1 to about 1.5, preferably from about 1 to about 1.4, more preferably from about 1 to about 1.2.

Still further, the relative standard deviation (RSTD) between Average Pore Sizes in the top, middle and bottom regions of the solid sheet formed by the anti-gravity heating/drying arrangement is no more than 20%, preferably no more than 15%, more preferably no more than 10%, most preferably no more than 5%. In contrast, a solid sheet formed by the impingement oven-based heating/drying arrangement may have a relative standard deviation (RSTD) between top/middle/bottom Average Pore Sizes of more than 20%, likely more than 25% or even more than 35% (as demonstrated in Example 2 hereinafter).

Preferably, the solid sheet of the present disclosure is further characterized by an Average Cell Wall Thickness of from about 5 μm to about 200 μm, preferably from about 10 μm to about 100 μm, more preferably from about 10 μm to about 80 μm, as measured by Test 2 hereinafter.

The solid article of the present disclosure may contain a small amount of water. Preferably, it is characterized by a final moisture content of from 0.5% to 25%, preferably from 1% to 20%, more preferably from 3% to 10%, by weight of said solid article, as measured by Test 4 hereinafter. An appropriate final moisture content in the resulting solid article may ensure the desired flexibility/deformability of the sheet, as well as providing soft/smooth sensory feel to the consumers. If the final moisture content is too low, the sheet may be too brittle or rigid. If the final moisture content is too high, the sheet may be too sticky, and its overall structural integrity may be compromised.

The solid sheet of the present disclosure may have a thickness ranging from about 0.6 mm to about 3.5 mm, preferably from about 0.7 mm to about 3 mm, more preferably from about 0.8 mm to about 2 mm, most preferably from about 1 mm to about 1.5 mm. Thickness of the solid sheet can be measured using Test 5 described hereinafter. The solid sheet after drying may be slightly thicker than the sheet of aerated wet pre-mixture, due to pore expansion that in turn leads to overall volume expansion.

The solid sheet of the present disclosure may further be characterized by a basis weight of from about 50 grams/m² to about 250 grams/m², preferably from about 80 grams/m² to about 220 grams/m², more preferably from about 100 grams/m² to about 200 grams/m², as measured by Test 6 described hereinafter.

Still further, the solid sheet of the present disclosure may have a density ranging from about 0.05 grams/cm³ to about 0.5 grams/cm³, preferably from about 0.06 grams/cm³ to about 0.4 grams/cm³, more preferably from about 0.07 grams/cm³ to about 0.2 grams/cm³, most preferably from about 0.08 grams/cm³ to about 0.15 grams/cm³, as measured by Test 7 hereinafter. Density of the solid sheet of the present disclosure is lower than that of the sheet of aerated wet pre-mixture, also due to pore expansion that in turn leads to overall volume expansion.

Furthermore, the solid sheet of the present disclosure can be characterized by a Specific Surface Area of from about 0.03 m²/g to about 0.25 m²/g, preferably from about 0.04 m²/g to about 0.22 m²/g, more preferably from 0.05 m²/g to 0.2 m²/g, most preferably from 0.1 m²/g to 0.18 m²/g, as measured by Test 8 described hereinafter. The Specific Surface Area of the solid sheet of the present disclosure may be indicative of its porosity and may impact its dissolution rate, e.g., the greater the Specific Surface Area, the more porous the sheet and the faster its dissolution rate.

### VI. Assembling of Multiple Sheets into Multilayer Dissolvable Solid Articles

Once the porous solid sheets as described hereinabove is formed, as described hereinabove, two or more of such sheets can be further assembled together to form multilayer dissolvable solid articles. Such multilayer dissolvable solid articles may have any desirable three-dimensional shapes, including but not limited to: spherical, cubic, rectangular, polygonal, oblong, cylindrical, rod, sheet, flower-shaped, fan-shaped, star-shaped, disc-shaped, and the like. The sheets can be combined and/or treated by any means known in the art, examples of which include but are not limited to, chemical means, mechanical means, and combinations thereof. Such combination and/or treatment steps are hereby collectively referred to as a “conversion” process, i.e., which functions to convert two or more flexible, dissolvable, porous sheets of the present disclosure into a dissolvable solid article with a desired three-dimensional shape.

The three-dimensional (3-D) multilayer structures formed by stacking multiple layers of porous solid sheets (which have an open cell foam or OCF structure defined by a Percent Open Cell Content of from about 80% to 100% and an Overall Average Pore Size of from about 100 μm to about 2000 μm) together are more dissolvable than a single-layer structure that has the same aspect ratio. This allows significant extension of the resulting multilayer structures along the thickness direction, to create three-dimensional product shapes that are easier to handle and more aesthetically pleasing to the consumers (e.g., products in form of thick pads or even cubes).

Specifically, a multilayer dissolvable solid article, which is formed by stacking multiple layers of the above-described dissolvable, porous sheets together is characterized by a maximum dimension D and a minimum dimension z (which is perpendicular to the maximum dimension D), while the ratio of D/z (hereinafter also referred to as the “Aspect Ratio”) ranges from 1 to about 10, preferably from about 1.4 to about 9, preferably from about 1.5 to about 8, more preferably from about 2 to about 7.

The solid article of the present disclosure, is preferably made from a multilayer sheet arrangement, it can be of any suitable shape, either regular or irregular, e.g., spherical, cubic, rectangular, polygonal, oblong, cylindrical, rod, sheet, flower-shaped, fan-shaped, star-shaped, disc-shaped, and the like. When the Aspect Ratio is 1, the dissolvable solid article has a spherical shape. When the Aspect Ratio is about 1.4, the dissolvable solid article has a cubical shape.

The solid article of the present disclosure may have a minimal dimension z that is greater than about 3 mm but less than about 20 cm, preferably from about 4 mm to about 10 cm, more preferably from about 5 mm to about 30 mm.

The above-described multilayer dissolvable solid article may comprise more than two of such flexible, dissolvable, porous sheets. For example, it may comprise from about 4 to about 50, preferably from about 5 to about 40, more preferably from about 6 to about 30, of said flexible, dissolvable, porous sheets. The improved OCF structures in the flexible, dissolvable, porous sheets made according to the present disclosure allow stacking of many sheets (e.g., 15-40) together, while still providing a satisfactory overall dissolution rate for the stack. In a particularly preferred embodiment of the present disclosure, the multilayer dissolvable solid article comprises from 15 to 40 layers of the above-described flexible, dissolvable, porous sheets and has an aspect ratio ranging from about 2 to about 7.

The multilayer dissolvable solid article of the present disclosure may comprise individual sheets of different colors, which are visual from an external surface (e.g., one or more side surfaces) of such article. Such visible sheets of different colors are aesthetically pleasing to the consumers. Further, the different colors of individual sheets may provide visual cues indicative of different benefit agents contained in the individual sheets. For example, the multilayer dissolvable solid article may comprise a first sheet that has a first color and contains a first benefit agent and a second sheet that has a second color and contains a second benefit, while the first color provides a visual cue indicative of the first benefit agent, and while the second color provides a visual cue indicative of the second benefit agent.

Further, one or more functional ingredients can be “sandwiched” between individual sheets of the multilayer dissolvable solid article as described hereinabove, e.g., by spraying, sprinkling, dusting, coating, spreading, dipping, injecting, or even vapor deposition. In order to avoid interference of such functional ingredients with the cutting seal or edge seal near the peripherals of the individual sheets, it is preferred that such functional ingredients are located within a central region between two adjacent sheets, which is defined as a region that is spaced apart from the peripherals of such adjacent sheets by a distance that is at least 10% of the maximum Dimension D.

Suitable functional ingredients can be selected from the group consisting of cleaning actives (surfactants, free perfumes, encapsulated perfumes, perfume microcapsules, silicones, softening agents, enzymes, bleaches, colorants, builders, rheology modifiers, pH modifiers, and combinations thereof).

### Test Methods

### Test 1: Scanning Electron Microscopic (SEM) Method for Determining Surface Average Pore Diameter of the Sheet Article

An Hitachi TM3000 Tabletop Microscope (S/N: 123104-04) is used to acquire SEM micrographs of samples. Samples of the solid sheet articles of the present disclosure are approximately 1 cm×1 cm in area and cut from larger sheets. Images are collected at a magnification of 50×, and the unit is operated at 15 kV. A minimum of 5 micrograph images are collected from randomly chosen locations across each sample, resulting in a total analyzed area of approximately 43.0 mm² across which the average pore diameter is estimated.

The SEM micrographs are then firstly processed using the image analysis toolbox in Matlab. Where required, the images are converted to grayscale. For a given image, a histogram of the intensity values of every single pixel is generated using the ‘imhist’ Matlab function. Typically, from such a histogram, two separate distributions are obvious, corresponding to pixels of the brighter sheet surface and pixels of the darker regions within the pores. A threshold value is chosen, corresponding to an intensity value between the peak value of these two distributions. All pixels having an intensity value lower than this threshold value are then set to an intensity value of 0, while pixels having an intensity value higher are set to 1, thus producing a binary black and white image. The binary image is then analyzed using ImageJ (https://imagej.nih.gov, version 1.52a), to examine both the pore area fraction and pore size distribution. The scale bar of each image is used to provide a pixel/mm scaling factor. For the analysis, the automatic thresholding and the analyze particles functions are used to isolate each pore. Output from the analyze function includes the area fraction for the overall image and the pore area and pore perimeter for each individual pore detected.

Average Pore Diameter is defined as D_{A}50:50% of the total pore area is comprised of pores having equal or smaller hydraulic diameters than the D_{A}50 average diameter.

Hydraulic diameter=‘4*Pore area (m²)/Pore perimeter (m)’.

It is an equivalent diameter calculated to account for the pores not all being circular.

### Test 2: Micro-Computed Tomographic (μCT) Method for Determining Overall or Regional Average Pore Size and Average Cell Wall Thickness of the Open Cell Foams (OCF)

Porosity is the ratio between void-space to the total space occupied by the OCF. Porosity can be calculated from μCT scans by segmenting the void space via thresholding and determining the ratio of void voxels to total voxels. Similarly, solid volume fraction (SVF) is the ratio between solid-space to the total space, and SVF can be calculated as the ratio of occupied voxels to total voxels. Both Porosity and SVF are average scalar-values that do not provide structural information, such as, pore size distribution in the height-direction of the OCF, or the average cell wall thickness of OCF struts.

To characterize the 3D structure of the OCFs, samples are imaged using a μCT X-ray scanning instrument capable of acquiring a dataset at high isotropic spatial resolution. One example of suitable instrumentation is the SCANCO system model 50 μCT scanner (Scanco Medical AG, Brüttisellen, Switzerland) operated with the following settings: energy level of 45 kVp at 133 μA; 3000 projections; 15 mm field of view; 750 ms integration time; an averaging of 5; and a voxel size of 3 μm per pixel. After scanning and subsequent data reconstruction is complete, the scanner system creates a 16 bit data set, referred to as an ISQ file, where grey levels reflect changes in x-ray attenuation, which in turn relates to material density. The ISQ file is then converted to 8 bit using a scaling factor.

Scanned OCF samples are normally prepared by punching a core of approximately 14 mm in diameter. The OCF punch is laid flat on a low-attenuating foam and then mounted in a 15 mm diameter plastic cylindrical tube for scanning. Scans of the samples are acquired such that the entire volume of all the mounted cut sample is included in the dataset. From this larger dataset, a smaller sub-volume of the sample dataset is extracted from the total cross section of the scanned OCF, creating a 3D slab of data, where pores can be qualitatively assessed without edge/boundary effects.

To characterize pore-size distribution in the height-direction, and the strut-size, Local Thickness Map algorithm, or LTM, is implemented on the subvolume dataset. The LTM Method starts with a Euclidean Distance Mapping (EDM) which assigns grey level values equal to the distance each void voxel is from its nearest boundary. Based on the EDM data, the 3D void space representing pores (or the 3D solid space representing struts) is tessellated with spheres sized to match the EDM values. Voxels enclosed by the spheres are assigned the radius value of the largest sphere. In other words, each void voxel (or solid voxel for struts) is assigned the radial value of the largest sphere that that both fits within the void space boundary (or solid space boundary for struts) and includes the assigned voxel.

The 3D labelled sphere distribution output from the LTM data scan can be treated as a stack of two dimensional images in the height-direction (or Z-direction) and used to estimate the change in sphere diameter from slice to slice as a function of OCF depth. The strut thickness is treated as a 3D dataset and an average value can be assessed for the whole or parts of the subvolume. The calculations and measurements were done using AVIZO Lite (9.2.0) from Thermo Fisher Scientific and MATLAB (R2017a) from Mathworks.

### Test 3: Percent Open Cell Content of the Sheet Article

The Percent Open Cell Content is measured via gas pycnometry. Gas pycnometry is a common analytical technique that uses a gas displacement method to measure volume accurately. Inert gases, such as helium or nitrogen, are used as the displacement medium. A sample of the solid sheet article of the present disclosure is sealed in the instrument compartment of known volume, the appropriate inert gas is admitted, and then expanded into another precision internal volume. The pressure before and after expansion is measured and used to compute the sample article volume.

ASTM Standard Test Method D2856 provides a procedure for determining the percentage of open cells using an older model of an air comparison pycnometer. This device is no longer manufactured. However, one can determine the percentage of open cells conveniently and with precision by performing a test which uses Micromeritics' AccuPyc Pycnometer. The ASTM procedure D2856 describes 5 methods (A, B, C, D, and E) for determining the percent of open cells of foam materials. For these experiments, the samples can be analyzed using an Accupyc 1340 using nitrogen gas with the ASTM foampyc software. Method C of the ASTM procedure is to be used to calculate to percent open cells. This method simply compares the geometric volume as determined using calipers and standard volume calculations to the open cell volume as measured by the Accupyc, according to the following equation:

Open cell percentage=Open cell volume of sample/Geometric volume of sample*100

It is recommended that these measurements be conducted by Micromeretics Analytical Services, Inc. (One Micromeritics Dr, Suite 200, Norcross, GA 30093). More information on this technique is available on the Micromeretics Analytical Services web sites (www.particletesting.com or www.micromeritics.com), or published in “Analytical Methods in Fine particle Technology” by Clyde Orr and Paul Webb.

### Test 4: Final Moisture Content of the Sheet Article

Final moisture content of the solid sheet article of the present disclosure is obtained by using a Mettler Toledo HX204 Moisture Analyzer (S/N B706673091). A minimum of 1 g of the dried sheet article is placed on the measuring tray. The standard program is then executed, with additional program settings of 10 minutes analysis time and a temperature of 110 °C.

### Test 5: Thickness of the Sheet Article

Thickness of the flexible, porous, dissolvable solid sheet article of the present disclosure is obtained by using a micrometer or thickness gage, such as the Mitutoyo Corporation Digital Disk Stand Micrometer Model Number IDS-1012E (Mitutoyo Corporation, 965 Corporate Blvd, Aurora, IL, USA 60504). The micrometer has a 1-inch diameter platen weighing about 32 grams, which measures thickness at an application pressure of about 0.09 psi (6.32 μm/cm²).

The thickness of the flexible, porous, dissolvable solid sheet article is measured by raising the platen, placing a section of the sheet article on the stand beneath the platen, carefully lowering the platen to contact the sheet article, releasing the platen, and measuring the thickness of the sheet article in millimeters on the digital readout. The sheet article should be fully extended to all edges of the platen to make sure thickness is measured at the lowest possible surface pressure, except for the case of more rigid substrates which are not flat.

### Test 6: Basis Weight of the Sheet Article

Basis Weight of the flexible, porous, dissolvable solid sheet article of the present disclosure is calculated as the weight of the sheet article per area thereof (grams/m²). The area is calculated as the projected area onto a flat surface perpendicular to the outer edges of the sheet article. The solid sheet articles of the present disclosure are cut into sample squares of 10 cm×10 cm, so the area is known. Each of such sample squares is then weighed, and the resulting weight is then divided by the known area of 100 cm² to determine the corresponding basis weight.

For an article of an irregular shape, if it is a flat object, the area is thus computed based on the area enclosed within the outer perimeter of such object. For a spherical object, the area is thus computed based on the average diameter as 3.14×(diameter/2)². For a cylindrical object, the area is thus computed based on the average diameter and average length as diameter×length. For an irregularly shaped three-dimensional object, the area is computed based on the side with the largest outer dimensions projected onto a flat surface oriented perpendicularly to this side. This can be accomplished by carefully tracing the outer dimensions of the object onto a piece of graph paper with a pencil and then computing the area by approximate counting of the squares and multiplying by the known area of the squares or by taking a picture of the traced area (shaded-in for contrast) including a scale and using image analysis techniques.

### Test 7: Density of the Sheet Article

Density of the flexible, porous, dissolvable solid sheet article of the present disclosure is determined by the equation: Calculated Density=Basis Weight of porous solid/(Porous Solid Thickness×1,000). The Basis Weight and Thickness of the dissolvable porous solid are determined in accordance with the methodologies described hereinabove.

### Test 8: Specific Surface Area of the Sheet Article

The Specific Surface Area of the flexible, porous, dissolvable solid sheet article is measured via a gas adsorption technique. Surface Area is a measure of the exposed surface of a solid sample on the molecular scale. The BET (Brunauer, Emmet, and Teller) theory is the most popular model used to determine the surface area and is based upon gas adsorption isotherms. Gas Adsorption uses physical adsorption and capillary condensation to measure a gas adsorption isotherm. The technique is summarized by the following steps; a sample is placed in a sample tube and is heated under vacuum or flowing gas to remove contamination on the surface of the sample. The sample weight is obtained by subtracting the empty sample tube weight from the combined weight of the degassed sample and the sample tube. The sample tube is then placed on the analysis port and the analysis is started. The first step in the analysis process is to evacuate the sample tube, followed by a measurement of the free space volume in the sample tube using helium gas at liquid nitrogen temperatures. The sample is then evacuated a second time to remove the helium gas. The instrument then begins collecting the adsorption isotherm by dosing krypton gas at user specified intervals until the requested pressure measurements are achieved. Samples may then analyzed using an ASAP 2420 with krypton gas adsorption. It is recommended that these measurements be conducted by Micromeretics Analytical Services, Inc. (One Micromeritics Dr, Suite 200, Norcross, GA 30093). More information on this technique is available on the Micromeretics Analytical Services web sites (www.particletesting.com or www.micromeritics.com), or published in a book, “Analytical Methods in Fine particle Technology”, by Clyde Orr and Paul Webb.

### Test 9: Dissolution Rate

The dissolution rate of dissolvable sheets or solid articles of the present disclosure is measured as follows:
1. 400 ml of deionized water at room temperature (25 °C) is added to a 1 L beaker, and the beaker is then placed on a magnetic stirrer plate.
2. A magnetic stirrer bar having length 23 mm and thickness of 10 mm is placed in the water and set to rotate at 300 rpm.
3. A Mettler Toledo S230 conductivity meter is calibrated to 1413 μS/cm and the probe placed in the beaker of water.
4. For each experiment, the number of samples is chosen such that a minimum of 0.2 g of sample is dissolved in the water.
5. The data recording function on the conductivity meter is started and the samples are dropped into the beaker. For 5 seconds a flat steel plate with diameter similar to that of the glass beaker is used to submerge the samples below the surface of the water and prevent them from floating to the surface.
6. The conductivity is recorded for at least 10 minutes, until a steady state value is reached.
7. In order to calculate the time required to reach 95% dissolution, a 10 second moving average is firstly calculated from the conductivity data. The time at which this moving average surpassed 95% of the final steady state conductivity value is then estimated and taken as the time required to achieve 95% dissolution.

### Examples

Four detergents (Compositions 1 to 4) were made and tested as detailed herein below.

### Test Method

### I. Preparation of Test Compositions

Tests were carried out using the following detergent compositions: Material additions shown as active material level in finished product (FP).

| | 1 | 2 | 3 | 4 |
|---|---|---|---|---|
| Ingredient | (g/L) | (g/L) | (g/L) | (g/L) |
| Polyvinyl Alcohol | 0.1500 | 0.1500 | 0.1500 | 0.1500 |
| (85,000 Molecular Weight) | | | | |
| Polyvinyl Alcohol | 0.0750 | 0.0750 | 0.0750 | 0.0750 |
| (25,000 Molecular Weight) | | | | |
| Glycerin | 0.0525 | 0.0525 | 0.0525 | 0.0525 |
| AE1S | 0.1727 | 0.1727 | 0.1727 | 0.1727 |
| AE3S | 0.0105 | 0.0105 | 0.0105 | 0.0105 |
| Amine Oxide | 0.0502 | 0.0502 | 0.0502 | 0.0502 |
| Soap powder | 0.0150 | 0.0150 | 0.0150 | 0.0150 |
| TAED | 0.1622 | 0.1622 | 0.1622 | 0.1622 |
| Zeolite | 0.0075 | 0.0075 | 0.0075 | 0.0075 |
| Water | 0.0450 | 0.0450 | 0.0450 | 0.0450 |
| Perfume capsules | 0.0095 | 0.0095 | 0.0095 | 0.0095 |
| Serine protease* | 0.0000 | 0.0385 | 0.0000 | 0.0385 |
| Metalloprotease** | 0.0000 | 0.0000 | 0.0826 | 0.0826 |
| NaOH | As required to achieve pH 7/8/9/or 10 | | | |
| Total weight | 0.7500 | 0.7885 | 0.8326 | 0.8711 |

*Bacillus lentus subtilisin GG36 (SEQ ID NO: 3) 16 L @40.3 mg/g
**Neutrase from Sigma Aldrich @ 18.2 mg/g

### II. Test Procedure

| Wash Equipment | Automated Tergotometer | | |
|---|---|---|---|
| Wash Volume | 1000 | ml | |
| Water Hardness | Tap water | | ~7 gpg hardness |
| Water Temperature | 25 | °C | |
| Detergent addition | 0.75 | g | detergent + enzymes ‘on top’ |

| | | |
|---|---|---|
| Protease stains | POM = Pigment oil milk | Centre for text materials B.V., |
| | CMCB = Chocolate milk | Het Scheur, Stoomloggerweg |
| | & carbon black | 11, 3133 KT Vlaardingen, |
| | CSM = Choc soy milk | Netherlands |
| Reps of stains | 2 internal reps | General Laboratory (with trap) |
| | 2 external reps | 3-piece, glass, 9 cm diameter |
| | | 1 L + Pyrex with side-arm. |
| Test method | 12 min wash | 25 °C |
| | 1 × 5 mins rinse | 15 °C |
| Measure of stain | Image analysis | VeriVide - Digieye system for |
| removal SRI | | textiles |

### Analysis of Protease Stain Removal on Fabric

Determination of protease stain removal on fabric was completed using the following procedure. Two external replicates of each stain were completed for each test product. 1000 ml of tap water was measured into each automated tergotometer pot at 25 °C. Dilute NaOH solution was then used to alter the pH of the water to pH 7, 8, 9 or 10. Each pH was tested for each of the products 1-4 above. 0.75 g of detergent was then added to each pot and for legs 2/3/4 the required enzymes were added on top. The stains were washed for 12 min wash at 25 °C followed by a 5 min rinse at 15 °C.

At the start of the test the stains were all pre-measured before washing using Digi eye. And they were measured again after washing
Results below show the measured level of stain removal per product per pH by SRI calculated as:
SRI=100*(ΔEb−ΔEa)/ΔEb
ΔEb=SQRT (L\hat{ }2+a \hat{ }2+b \hat{ }2) before washing
ΔEa=SQRT (L\hat{ }2+a \hat{ }2+b \hat{ }2) after washing

pH 7 results

| | | | | | Delta | | | Delta |
|---|---|---|---|---|---|---|---|---|
| Product | 1 | | 2 | | vs 1 | 3 | | vs 1 |
| Overall SRI | 5.29 | stdev | 19.19 | stdev | 13.90 | 18.58 | stdev | 13.29 |
| POM | 9.13 | 0.83 | 19.21 | 1.52 | 10.08 | 21.98 | 0.80 | 12.85 |
| CMCB | 9.88 | 1.67 | 13.78 | 2.32 | 3.90 | 14.81 | 0.84 | 4.93 |
| CSM | −3.15 | 0.52 | 24.57 | 2.42 | 27.72 | 18.95 | 0.45 | 22.10 |

| | | |
|---|---|---|
| Product | 4 | Delta vs 1 |

| | | | |
|---|---|---|---|
| Overall SRI | 28.15 | stdev | 22.86 |
| POM | 30.46 | 2.78 | 21.33 |
| CMCB | 25.82 | 0.14 | 15.94 |
| CSM | 28.17 | 2.24 | 31.32 |

pH 8 results

| | | | | | Delta | | | Delta |
|---|---|---|---|---|---|---|---|---|
| Product | 1 | | 2 | | vs 1 | 3 | | vs 1 |
| Overall SRI | 4.62 | stdev | 17.90 | stdev | 13.27 | 20.09 | stdev | 15.47 |
| POM | 8.29 | 0.85 | 19.32 | 1.32 | 11.03 | 24.15 | 1.92 | 15.86 |
| CMCB | 9.92 | 0.57 | 11.11 | 1.89 | 1.19 | 17.67 | 1.94 | 7.75 |
| CSM | −4.34 | 0.43 | 23.26 | 1.52 | 27.6 | 18.45 | 0.88 | 22.79 |

| | | |
|---|---|---|
| Product | 4 | Delta vs 1 |

| | | | |
|---|---|---|---|
| Overall SRI | 28.10 | stdev | 23.48 |
| POM | 31.48 | 0.78 | 23.19 |
| CMCB | 24.49 | 0.50 | 14.57 |
| CSM | 28.33 | 2.41 | 32.67 |

pH 9 results

| | | | | | Delta | | | Delta |
|---|---|---|---|---|---|---|---|---|
| Product | 1 | | 2 | | vs 1 | 3 | | vs 1 |
| Overall SRI | 4.90 | stdev | 15.57 | stdev | 10.67 | 24.10 | stdev | 19.20 |
| POM | 9.00 | 1.82 | 17.5 | 2.41 | 8.50 | 27.66 | 2.54 | 18.66 |
| CMCB | 10.14 | 1.53 | 7.58 | 1.68 | −2.56 | 20.87 | 2.39 | 10.73 |
| CSM | −4.44 | 0.74 | 21.64 | 1.44 | 26.08 | 23.77 | 1.99 | 28.21 |

| Product | 4 | | Delta vs 1 |
|---|---|---|---|
| Overall SRI | 28.14 | stdev | 23.24 |
| POM | 32.08 | 1.69 | 23.08 |
| CMCB | 23.34 | 0.89 | 13.20 |
| CSM | 28.99 | 2.67 | 33.43 |

pH 10 results

| | | | | | Delta | | | Delta |
|---|---|---|---|---|---|---|---|---|
| Product | 1 | | 2 | | vs 1 | 3 | | vs 1 |
| Overall SRI | 3.82 | stdev | 6.63 | stdev | 2.81 | 29.07 | stdev | 25.24 |
| POM | 9.13 | 0.75 | 11.76 | 1.76 | 2.63 | 39.40 | 2.38 | 30.27 |
| CMCB | 9.33 | 1.05 | 1.74 | 1.33 | −7.59 | 23.66 | 0.35 | 14.33 |
| CSM | −6.99 | 1.43 | 6.40 | 0.86 | 13.39 | 24.14 | 2.45 | 31.13 |

| Product | 4 | | Delta vs 1 |
|---|---|---|---|
| Overall SRI | 29.00 | stdev | 25.18 |
| POM | 38.19 | 1.4 | 29.06 |
| CMCB | 22.99 | 2.02 | 13.66 |
| CSM | 25.83 | 7.04 | 32.82 |

Overall SRI Across pH Summary:

The examples demonstrate the efficacy of a dual serine protease and metalloprotease enzyme system across pH 7 to 10.

As used in this specification and the claims that follow, the articles “a”, “an”, and “the” include singular and plural references unless the context clearly dictates otherwise. As such, the terms “a” or “an”, “one or more” and “at least one” can be used interchangeably herein. Thus, for example, “a component” may include one or more components unless the reference is specifically indicated as being singular.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any product or method disclosed or claimed herein or that it alone, or in any combination with any other reference or references, teaches, suggests or discloses any such product or method. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

What is claimed is:

1. A water-soluble unit-dose solid detergent article comprising a porous structure, the article comprising:
a surfactant system
a serine protease; and
a metalloprotease.

2. The solid detergent article according to claim 1, wherein the solid detergent article comprises from about 10 to about 80% by weight of the article of the surfactant system and wherein the surfactant system comprises one or more surfactants selected from the group consisting of anionic, non-ionic, amphoteric surfactants, and a mixture thereof.

3. The solid detergent article according to claim 1, wherein the wherein the solid detergent article comprises a surfactant system and the surfactant system comprises an anionic surfactant selected from the group consisting of alkylbenzene sulfonate, alkylethoxylated sulfate, and a mixture thereof.

4. The solid detergent article according to claim 1, wherein the solid detergent article comprises a surfactant system and the surfactant system comprises linear alkylbenzene sulfonate and alkylethoxylated sulfate in a weight ratio of linear alkylbenzene sulfonate to alkylethoxylated sulfate of greater than about 1.

5. The solid detergent article according to claim 1, the solid detergent article comprises a surfactant system and wherein the surfactant system comprises amino oxide and alkylethoxylated sulfate, in a weight ratio of from about 8:1 to about 1:1.

6. The solid detergent article according to claim 1, wherein the solid detergent article comprises from about 0.5 to about 10% by weight of the article of C₆-C₂₀ linear or branched alkylalkoxylated alcohols (AA) having a weight average degree of alkoxylation ranging from about 5 to about 15, and combinations thereof.

7. The solid detergent article according to claim 1, wherein the metalloprotease is a metalloprotease selected from the M4, M7, M23 or M35 family.

8. The solid detergent article according to claim 1, wherein the metalloprotease is a metalloprotease variant having a sequence identity of at least about 60% to the metalloprotease of SEQ ID NO:1 with one or more mutations selected from the group consisting of S129I, S129V, S129L, F130L, M138I, M138L, V190I, V190L, D220E and D220.

9. The solid detergent article according to claim 1, wherein the metalloprotease is a metalloprotease variant having a sequence identity of at least about 90% to the metalloprotease of SEQ ID NO:1 with one or more mutations selected from the group consisting of S129I, F130L, M138L, V1901 and D220P.

10. The solid detergent article according to claim 1, wherein the metalloprotease is a metalloprotease variant having a sequence identity of at least about 60% to the metalloprotease of SEQ ID NO:2.

11. The solid detergent article according to claim 1, wherein the serine protease is a variant, wherein said variant has at least about 90% amino acid identity with Bacillus lentus subtilisin GG36 protease comprising the amino acid sequence shown in SEQ ID NO:3.

12. The solid detergent article according to claim 1, wherein the serine protease is a variant, wherein said variant has at least about 90% amino acid identity with Bacillus lentus subtilisin GG36 protease comprising the amino acid sequence shown in SEQ ID NO:3 and said variant comprises an amino acid sequence comprising one of the combinations of amino acid substitutions: T022A-S103A-V104 IN116L-G159D-S188D-A232V-Q245R-N248D-E271F, T022A-S101G-V104I-N116L-G159D-S188D-A232V-Q245R-N248D-E271F, T022A-S101G-S103A-V104I-N116L-S188D-A232V-Q245R-N248D-E271F, T022A-S101G-S103A-V104I-N116L-G159D-S188D-Q245R-N248D-E271F, T022A-S101G-S103A-V104I-N116L-G159D-S188D-A232V-N248D-E271F, T022A-S101G-S103A-V104I-N116L-G159D-S188D-A232V-Q245R-E271F, T022A-S101G-S103A-V104I-N116L-G159D-S188D-A232V-Q245R-N248D-E271F, T022A-T033S-S101G-S103A-V104I-N116L-G159D-S188D-T213A-A232V-Q245R-N248D-E271F, T022A-V068A-S101G-S103A-V104 IN116L-G159D-S188D-T213A-A232V-Q245R-N248D-E271F, T022A-S101G-S103A-V104 IN116L-G159D-S188D-T213A-A232V-Q245R-N248D-E271F, T022A-S101G-S103A-V104 IN116L-S128L-G159D-S188D-A232V-Q245R-N248D-E271F, T022A-V068A-S101G-S103A-V104I-N116L-G159D-S188D-A232V-Q245R-N248D-E271F, T022A-S101G-S103A-V104I-N116L-G159D-S188D-A232V-Q245R-N248D, T022A-S101G-S103A-V104I-N116L-S128L-G159D-S188D-T213A-A232V-Q245R-N248D-E271F, T022A-N062D-S101G-S103A-V104I-N116L-G159D-S188D-T213A-A232V-Q245R-N248D-E271F, T022A-T033S-S101G-S103A-V104I-N116L-S128L-G159D-S188D-A232V-Q245R-N248D-E271F, T022A-T033S-S101G-S103A-V104I-N116L-G159D-S188D-A232V-Q245R-N248D-E271F, T022A-T033S-S101G-S103A-V104I-N116L-S128L-G159D-S188D-T213A-A232V-Q245R-N248D-E271F, wherein amino acid positions of the subtilisin variant are numbered according to the numbering of corresponding amino acid positions in the amino acid sequence of Bacillus amyloliquefaciens subtilisin BPN′ shown in SEQ ID NO:4

13. The solid detergent article according to claim 1, wherein the serine protease is a variant, wherein said variant has at least about 90% amino acid identity with Bacillus lentus subtilisin GG36 protease comprising the amino acid sequence shown in SEQ ID NO:3 and said variant comprises a combination of amino acid substitutions selected from T022A-S103A-V104I-N116L-G159D-S188D-A232V-Q245R-N248D-E271F, T022A-S101G-V104I-N116L-G159D-S188D-A232V-Q245R-N248D-E271F, T022A-S101G-S103A-V104I-N116L-S188D-A232V-Q245R-N248D-E271F, T022A-S101G-S103A-V104I-N116L-G159D-S188D-Q245R-N248D-E271F, T022A-S101G-S103A-V104I-N116L-G159D-S188D-A232V-N248D-E271F, T022A-S101G-S103A-V104I-N116L-G159D-S188D-A232V-Q245R-E271F, T022A-S101G-S103A-V104I-N116L-G159D-S188D-A232V-Q245R-N248D-E271F, T022A-T033S-S101G-S103A-V104I-N116L-G159D-S188D-T213A-A232V-Q245R-N248D-E271F, T022A-V068A-S101G-S103A-V104I-N116L-G159D-S188D-T213A-A232V-Q245R-N248D-E271F, T022A-S101G-S103A-V104I-N116L-G159D-S188D-T213A-A232V-Q245R-N248D-E271F, T022A-S101G-S103A-V104I-N116L-S128L-G159D-S188D-A232V-Q245R-N248D-E271F, T022A-V068A-S101G-S103A-V104I-N116L-G159D-S188D-A232V-Q245R-N248D-E271F, and wherein amino acid positions of the subtilisin variant are numbered according to the numbering of corresponding amino acid positions in the amino acid sequence of Bacillus amyloliquefaciens subtilisin BPN′ shown in SEQ ID NO:4.

14. The solid detergent article according to claim 1 further comprising an additional enzyme selected from the group consisting of proteases, amylase, cellulase, lipases, xyloglucanases, mannanases, nucleases, pectate lyases, perhydrolase, and a mixture thereof.

15. The solid detergent article according to claim 1, further comprising a water-soluble polymer.

16. The solid detergent article according to claim 1, wherein the solid detergent article has an open celled foam structure having a Percent Open Cell Content of from about 80% to about 100% and an Overall Average Pore Size of from about 100 μm to about 2000 μm.

17. The solid detergent article according to claim 1, wherein the porous structure is made by one or more sheets and wherein each of said sheets is characterized by a Percent Open Cell Content of from about 80% to about 100% and an Overall Average Pore Size of from about 100 μm to about 2000 μm.

18. The solid detergent article according to claim 1, further comprising an inorganic dissolution aid, a rheology modifier, a perfume microcapsule, a hueing agent, a bleaching agent, an aversive agent, or a combination thereof.

19. The solid detergent article according to claim 1, wherein the porous structure is made by one or more sheets and wherein the one or more sheets are characterized by:
a Percent Open Cell Content of from about 90% to about 100%; and/or
an Overall Average Pore Size of from about 200 μm to about 600 μm; and/or
an Average Cell Wall Thickness of from about 10 μm to about 80 μm; and/or
a final moisture content of from 3% to about 10%, by weight of said solid sheet article; and/or
a thickness of from about 1 mm to about 1.5 mm; and/or
a basis weight of from about 100 grams/m² to about 200 grams/m²; and/or
a density of from about 0.05 grams/cm³ to about 0.5 grams/cm³; and/or
a Specific Surface Area of from about 0.03 m²/g to about 0.25 m²/g.

20. A method of cleaning a surface, the method comprising the step of adding the solid detergent article according to claim 1 to water to create a wash liquor, subjecting the surface to the wash liquor and rinsing the surface wherein the surface is a fabric.


SEQUENCE LISTING (4 sequences)

SEQ ID NO: 1 - protein, 300 aa, Bacillus amyloliquefaciens
AATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 2 - protein, 304 aa, Paenibacillus ehimensis
ATGTGKGVLGDTKSFTVGTSGSSYVMTDSTRGKGIQTYTASNRTSLPGSTVTSSSSTFNDPASVDAHAYAQKVYDFYKSNFNRNSIDGNGLAIRSTTHYSTRYNNAFWNGSQMVYGDGDGSQFIAFSGDLDVVGHELTHGVTEYTANLEYYGQSGALNESISDIFGNTIEGKNWMVGDAIYTPGVSGDALRYMDDPTKGGQPARMADYNNTSADNGGVHTNSGIPNKAYYLLAQGGTFGGVNVTGIGRSQAIQIVYRALTYYLTSTSNFSNYRSAMVQASTDLYGANSTQTTAVKNSLSAVGIN

SEQ ID NO: 3 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 4 - protein, 275 aa, Bacillus amyloliquefaciens [sequence omitted]